(19) United States
(12) Patent Application Publication
(10) Pub. No.: US 2014/0081981 A1
(43) Pub. Date: Mar. 20, 2014

(54) Methods, Systems, and Program Products for Identifying a Matched Tag Set

(71) Applicant: DEEP RIVER VENTURES, LLC, Raleigh, NC (US)

(72) Inventor: Robert Paul Morris, Raleigh, NC (US)

(73) Assignee: DEEP RIVER VENTURES, LLC, Raleigh, NC (US)

(21) Appl. No.: 13/622,368

(22) Filed: Sep. 19, 2012

(51) Int. Cl. G06F 17/30

(52) U.S. Cl. 707/741; 707/E17.083

(57) ABSTRACT

Methods and systems are described for identifying a matched tag set. In one aspect, a first resource is identified that is first tagged with a first tag associated with a first tagging criterion by a first matched tag and that is second tagged with the first tag associated with a second tagging criterion by a second matched tag. Selection information is received identifying the first tag. Based on the first tagging criterion, a first set is identified that includes at least one resource when the selection information identifies the first matched tag, wherein each resource in the first set is tagged with the first tag. Based on the second tagging criterion, a second resource, not included in the first set, is identified that is tagged with the first tag when the selection information identifies the second matched tag.

### RELATED APPLICATIONS

This application is related to the following commonly owned U.S. patent applications: application Ser. No. 13/622,366 (Docket No DRV0002) filed on 2012 Sep. 19, entitled “Methods, Systems, and Program Products for Tagging a Resource”;

application Ser. No. 13/622,367 (Docket No DRV0005) filed on 2012 Sep. 19, entitled “Methods, Systems, and Program Products for Distinguishing Tags for a Resource”;

application Ser. No. 13/622,372 (Docket No DRV0007) filed on 2012 Sep. 19, entitled “Methods, Systems, and Program Products for Navigating Tagging Contexts””;

application Ser. No. 13/622,370 (Docket No DRV0008) filed on 2012 Sep. 19, entitled “Methods, Systems, and Program Products for Automatically Managing Tagging of a Resource”; and

application Ser. No. 13/622,371 (Docket No DRV0009) filed on 2012 Sep. 19, entitled “Methods, Systems, and Program Products for Locating Tagged Resources in a Resource Scope”.

### BACKGROUND

Tagging has become a common way to allow users to categorize and/or otherwise create relationships between resources on the Web. Resources, such as images, video, audio, documents, and other web content are tagged every day. One of the disadvantages of tagging is that it tags can be ambiguous. “Green” can indicate a color, a political party, an environmental attribute, or a family name, among other things. Placing tags within contexts to restrict what they indicate is one solution, but contextual tagging can restrict the use of a tag.

Accordingly, there exists a need for methods, systems, and computer program products for identifying a matched tag set.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

Methods and systems are described for identifying a matched tag set. In one aspect, the method includes identifying a first tagging of a first resource with a first tag that is associated with a first tagging criterion by a first matched tag and identifying a second tagging of the first resource with the first tag that is associated with a second tagging criterion by a second matched tag. The method further includes receiving selection information identifying the first tag. The method still further includes identifying, based on the first tagging criterion, a first set including at least one resource when the selection information identifies the first matched tag, wherein each resource in the first set is tagged with the first tag. The method additionally includes identifying, based on the second tagging criterion, a second resource, not included in the first set, tagged with the first tag when the selection information identifies the second matched tag. Performing at least one the preceding actions comprising the method includes execution of an instruction by a processor.

Also, a system for identifying a matched tag set is described that includes one or more processors and logic encoded in one or more non-transitory media for execution by the one or more processors that when executed is operable for identifying a first tagging of a first resource with a first tag that is associated with a first tagging criterion by a first matched tag and identifying a second tagging of the first resource with the first tag that is associated with a second tagging criterion by a second matched tag; receiving selection information identifying the first tag; identifying, based on the first tagging criterion, a first set including at least one resource when the selection information identifies the first matched tag, wherein each resource in the first set is tagged with the first tag; and identifying, based on the second tagging criterion, a second resource, not included in the first set, tagged with the first tag when the selection information identifies the second matched tag.

Further, a system for identifying a matched tag set is described. The system includes a tagging component for identifying a first tagging of a first resource with a first tag that is associated with a first tagging criterion by a first matched tag and identifying a second tagging of the first resource with the first tag that is associated with a second tagging criterion by a second matched tag. The system further includes a tag handler component for receiving selection information identifying the first tag. The system still further includes a match set component for identifying, based on the first tagging criterion, a first set including at least one resource when the selection information identifies the first matched tag, wherein each resource in the first set is tagged with the first tag. The system additionally includes a match set for identifying, based on the second tagging criterion, a second resource, not included in the first set, tagged with the first tag when the selection information identifies the second matched tag. The system also includes a processor, wherein at least one of the tagging component, the tag handler component, and the match set component includes an instruction that is executed by the processor during operation of the system.

### BRIEF DESCRIPTION OF THE DRAWINGS

Objects and advantages of the present invention will become apparent to those skilled in the art upon reading this description in conjunction with the accompanying drawings, in which like reference numerals have been used to designate like or analogous elements, and in which:

FIG. 1 is a block diagram illustrating an exemplary execution environment, including and/or otherwise provided by a hardware device, in which the subject matter may be implemented;

FIG. 2A is a flow diagram illustrating a method for identifying a matched tag set according to an aspect of the subject matter described herein;

FIG. 2B is a flow diagram illustrating a method for identifying a matched tag set according to an aspect of the subject matter described herein;

FIG. 3A is a block diagram illustrating an arrangement of components for identifying a matched tag set according to another aspect of the subject matter described herein;

FIG. 3B is a block diagram illustrating an arrangement of components for identifying a matched tag set according to another aspect of the subject matter described herein;

FIG. 4A is a block diagram illustrating an arrangement of components for identifying a matched tag set according to another aspect of the subject matter described herein;

FIG. 4B is a block diagram illustrating an arrangement of components for identifying a matched tag set according to another aspect of the subject matter described herein;

FIG. 4C is a block diagram illustrating an arrangement of components for identifying a matched tag set according to another aspect of the subject matter described herein;

FIG. 4D is a block diagram illustrating an arrangement of components for identifying a matched tag set according to another aspect of the subject matter described herein;

FIG. 5 is a network diagram illustrating a system for identifying a matched tag set according to another aspect of the subject matter described herein;

FIG. 6A is a diagram illustrating a user interface presented via a display according to another aspect of the subject matter described herein; and

FIG. 6B is a diagram illustrating a user interface presented via a display according to another aspect of the subject matter described herein.

### DETAILED DESCRIPTION

One or more aspects of the disclosure are described with reference to the drawings, wherein like reference numerals are generally utilized to refer to like elements throughout, and wherein the various structures are not necessarily drawn to scale. In the following description, for purposes of explanation, numerous specific details are set forth in order to provide a thorough understanding of one or more aspects of the disclosure. It may be evident, however, to one skilled in the art, that one or more aspects of the disclosure may be practiced with a lesser degree of these specific details. In other instances, well-known structures and devices are shown in block diagram form in order to facilitate describing one or more aspects of the disclosure.

Unless otherwise defined, all technical and scientific terms used herein have the same meaning as commonly understood by one of ordinary skill in the art to which this disclosure belongs. Although methods, components, and devices similar or equivalent to those described herein can be used in the practice or testing of the subject matter described herein, suitable methods, components, and devices are described below.

All publications, patent applications, patents, and other references mentioned herein are incorporated by reference in their entirety. In case of conflict, the present specification, including definitions, will control. In addition, the materials, methods, and examples are illustrative only and not intended to be limiting.

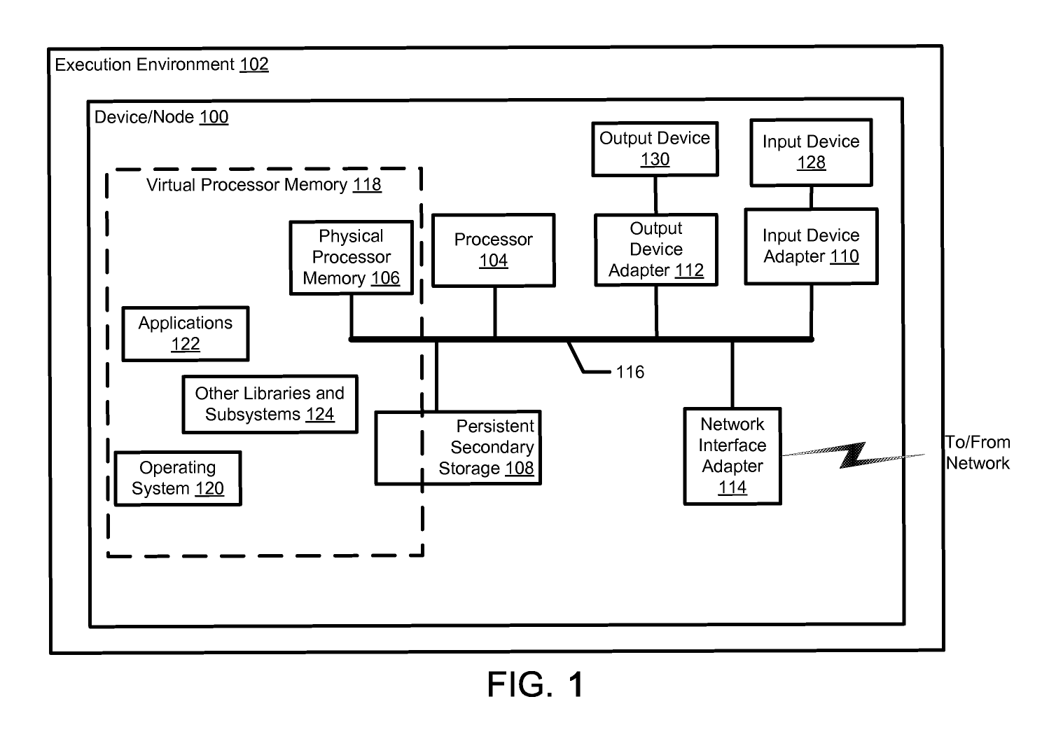

An exemplary device included in an execution environment that may be configured according to the subject matter is illustrated in FIG. 1. An “execution environment”, as used herein, is an arrangement of hardware and, in some aspects, software that may be further configured to include and/or otherwise host an arrangement of components for performing a method of the subject matter described herein. An execution environment includes and/or is otherwise provided by one or more devices. The execution environment is said to be the execution environment of the device and/or devices. An execution environment may be and/or may include a virtual execution environment including software components operating in a host execution environment. Exemplary devices included in and/or otherwise providing suitable execution environments for configuring according to the subject matter include personal computers, notebook computers, tablet computers, servers, portable electronic devices, handheld electronic devices, mobile devices, multiprocessor devices, distributed systems, consumer electronic devices, routers, communication servers, and/or any other suitable devices. Those skilled in the art will understand that the components illustrated in FIG. 1 are exemplary and may vary by particular execution environment.

FIG. 1 illustrates a hardware device 100 included in an execution environment 102. FIG. 1 illustrates that execution environment 102 includes a processor 104, such as one or more microprocessors; a physical processor memory 106 including storage locations identified by addresses in a physical memory address space of processor 104; a persistent secondary storage 108, such as one or more hard drives and/or flash storage media; an input device adapter 110, such as a key or keypad hardware, a keyboard adapter, and/or a mouse adapter; an output device adapter 112, such as a display and/or an audio adapter for presenting information to a user; a network interface component, illustrated by a network interface adapter 114, for communicating via a network such as a LAN and/or WAN; and a communication mechanism that operatively couples elements 104-114, illustrated as a bus 116. Elements 104-114 may be operatively coupled by various means. Bus 116 may comprise any type of bus architecture, including a memory bus, a peripheral bus, a local bus, and/or a switching fabric.

As used herein a “processor” is an instruction execution machine, apparatus, or device. A processor may include one or more electrical, optical, and/or mechanical components that operate in interpreting and executing program instructions. Exemplary processors include one or more microprocessors, digital signal processors (DSPs), graphics processing units, application-specific integrated circuits (ASICs), optical or photonic processors, and/or field programmable gate arrays (FPGAs). Processor 104 may access machine code instructions and data via one or more memory address spaces in addition to the physical memory address space. A memory address space includes addresses identifying locations in a processor memory. The addresses in a memory address space are included in defining a processor memory. Processor 104 may have more than one processor memory. Thus, processor 104 may have more than one memory address space. Processor 104 may access a location in a processor memory by processing an address identifying the location. The processed address may be identified by an operand of a machine code instruction and/or may be identified by a register or other portion of processor 104.

FIG. 1 illustrates a virtual processor memory 118 spanning at least part of physical processor memory 106 and may span at least part of persistent secondary storage 108. Virtual memory addresses in a memory address space may be mapped to physical memory addresses identifying locations in physical processor memory 106. An address space for identifying locations in a virtual processor memory is referred to as a virtual memory address space; its addresses are referred to as virtual memory addresses; and its processor memory is referred to as a virtual processor memory or virtual memory. The term “processor memory” may refer to physical processor memory, such as processor memory 106, and/or may refer to virtual processor memory, such as virtual processor memory 118, depending on the context in which the term is used.

Physical processor memory 106 may include various types of memory technologies. Exemplary memory technologies include static random access memory (SRAM) and/or dynamic RAM (DRAM) including variants such as dual data rate synchronous DRAM (DDR SDRAM), error correcting code synchronous DRAM (ECC SDRAM), RAMBUS DRAM (RDRAM), and/or XDR™ DRAM. Physical processor memory 106 may include volatile memory as illustrated in the previous sentence and/or may include nonvolatile memory such as nonvolatile flash RAM (NVRAM) and/or ROM.

Persistent secondary storage 108 may include one or more flash memory storage devices, one or more hard disk drives, one or more magnetic disk drives, and/or one or more optical disk drives. Persistent secondary storage may include a removable data storage medium. The drives and their associated tangible computer readable storage media provide volatile and/or nonvolatile storage for computer-readable instructions, data structures, program components, and other data for execution environment 102.

Execution environment 102 may include software components stored in persistent secondary storage 108, in remote storage accessible via a network, and/or in a processor memory. FIG. 1 illustrates execution environment 102 including an operating system 120, one or more applications 122, and other program code and/or data components illustrated by other libraries and subsystems 124. In an aspect, some or all software components may be stored in locations accessible to processor 104 in a shared memory address space shared by the software components. The software components accessed via the shared memory address space are stored in a shared processor memory defined by the shared memory address space. In another aspect, a first software component may be stored in one or more locations accessed by processor 104 in a first address space and a second software component may be stored in one or more locations accessed by processor 104 in a second address space. The first software component is stored in a first processor memory defined by the first address space and the second software component is stored in a second processor memory defined by the second address space.

Software components typically include instructions executed by processor 104 in a computing context referred to as a “process”. A process may include one or more “threads”. A “thread” includes a sequence of instructions executed by processor 104 in a computing sub-context of a process. The terms “thread” and “process” may be used interchangeably herein when a process includes only one thread.

Execution environment 102 may receive user-provided information via one or more input devices illustrated by an input device 128. Input device 128 provides input information to other components in execution environment 102 via input device adapter 110. Execution environment 102 may include an input device adapter for a keyboard, a touch screen, a microphone, a joystick, a television receiver, a video camera, a still camera, a document scanner, a fax, a phone, a modem, a network interface adapter, and/or a pointing device, to name a few exemplary input devices.

Input device 128 included in execution environment 102 may be included in device 100 as FIG. 1 illustrates or may be external (not shown) to device 100. Execution environment 102 may include one or more internal and/or external input devices. External input devices may be connected to device 100 via corresponding communication interfaces such as a serial port, a parallel port, and/or a universal serial bus (USB) port. Input device adapter 110 receives input and provides a representation to bus 116 to be received by processor 104, physical processor memory 106, and/or other components included in execution environment 102.

An output device 130 in FIG. 1 exemplifies one or more output devices that may be included in and/or that may be external to and operatively coupled to device 100. For example, output device 130 is illustrated connected to bus 116 via output device adapter 112. Output device 130 may be a display device. Exemplary display devices include liquid crystal displays (LCDs), light emitting diode (LED) displays, and projectors. Output device 130 presents output of execution environment 102 to one or more users. In some embodiments, an input device may also include an output device. Examples include a phone, a joystick, and/or a touch screen. In addition to various types of display devices, exemplary output devices include printers, speakers, tactile output devices such as motion-producing devices, and other output devices producing sensory information detectable by a user. Sensory information detected by a user is referred herein to as “sensory input” with respect to the user.

A device included in and/or otherwise providing an execution environment may operate in a networked environment communicating with one or more devices via one or more network interface components. The terms “communication interface component” and “network interface component” are used interchangeably herein. FIG. 1 illustrates network interface adapter (NIA) 114 as a network interface component included in execution environment 102 to operatively couple device 100 to a network. A network interface component includes a network interface hardware (NIH) component and optionally a network interface software (NIS) component.

Exemplary network interface components include network interface controller components, network interface cards, network interface adapters, and line cards. A node may include one or more network interface components to interoperate with a wired network and/or a wireless network. Exemplary wireless networks include a BLUETOOTH network, a wireless 802.11 network, and/or a wireless telephony network (e.g., a cellular, PCS, CDMA, and/or GSM network). Exemplary network interface components for wired networks include Ethernet adapters, Token-ring adapters, FDDI adapters, asynchronous transfer mode (ATM) adapters, and modems of various types. Exemplary wired and/or wireless networks include various types of LANs, WANs, and/or personal area networks (PANs). Exemplary networks also include intranets and internets such as the Internet.

The terms “network node” and “node” in this document both refer to a device having a network interface component for operatively coupling the device to a network. Further, the terms “device” and “node” used herein may refer to one or more devices and nodes, respectively, providing and/or otherwise included in an execution environment unless clearly indicated otherwise.

The user-detectable outputs of a user interface are generically referred to herein as “user interface elements” or abbreviated as “UI elements”. More specifically, visual outputs of a user interface are referred to herein as “visual interface elements”. A visual interface element may be a visual output of a graphical user interface (GUI). Exemplary visual interface elements include windows, textboxes, sliders, list boxes, drop-down lists, spinners, various types of menus, toolbars, ribbons, combo boxes, tree views, grid views, navigation tabs, scrollbars, labels, tooltips, text in various fonts, balloons, dialog boxes, and various types of button controls including check boxes and radio buttons. An application interface may include one or more of the elements listed. Those skilled in the art will understand that this list is not exhaustive. The terms “visual representation”, “visual output”, and “visual interface element” are used interchangeably in this document. Other types of UI elements include audio outputs referred to as “audio interface elements”, tactile outputs referred to as “tactile interface elements”, and the like.

A visual output may be presented in a two-dimensional presentation where a location may be defined in a two-dimensional space having a vertical dimension and a horizontal dimension. A location in a horizontal dimension may be referenced according to an X-axis and a location in a vertical dimension may be referenced according to a Y-axis. In another aspect, a visual output may be presented in a three-dimensional presentation where a location may be defined in a three-dimensional space having a depth dimension in addition to a vertical dimension and a horizontal dimension. A location in a depth dimension may be identified according to a Z-axis. A visual output in a two-dimensional presentation may be presented as if a depth dimension existed allowing the visual output to overlie and/or underlie some or all of another visual output.

A “user interface (UI) element handler” component, as the term is used herein, includes a component of configured to send information representing a program entity for presenting a user-detectable representation of the program entity by an output device, such as a display. A “program entity” is an object included in and/or otherwise processed by an application or executable. The user-detectable representation is presented based on the sent information. Information that represents a program entity for presenting a user detectable representation of the program entity by an output device is referred to herein as “presentation information”. Presentation information may include and/or may otherwise identify data in one or more formats. Exemplary formats include image formats such as raw pixel data, JPEG, video formats such as MP4, markup language data such as hypertext markup language (HTML) and other XML-based markup, a bit map, and/or instructions such as those defined by various script languages, byte code, and/or machine code. For example, a web page received by a user agent from a remote application provider may include HTML, ECMAScript, and/or byte code for presenting one or more UI elements included in a user interface of the remote application. Components configured to send information representing one or more program entities for presenting particular types of output by particular types of output devices include visual interface element handler components, audio interface element handler components, tactile interface element handler components, and the like.

A representation of a program entity may be stored and/or otherwise maintained in a presentation space. As used in this document, the term “presentation space” refers to a storage region allocated and/or otherwise provided for storing presentation information, which may include audio, visual, tactile, and/or other sensory data for presentation by and/or on an output device. For example, a buffer for storing an image and/or text string may be a presentation space as sensory information for a user. A presentation space may be physically and/or logically contiguous or non-contiguous. A presentation space may have a virtual as well as a physical representation. A presentation space may include a storage location in a processor memory, secondary storage, a memory of an output adapter device, and/or a storage medium of an output device. A screen of a display, for example, is a presentation space.

As used herein, the terms “program” and “executable” refer to any data representation that may be translated into a set of machine code instructions and may optionally include associated program data. The terms are used interchangeably herein. Program representations other than machine code include object code, byte code, and source code. Object code includes a set of instructions and/or data elements that either are prepared for linking prior to loading or are loaded into an execution environment. When in an execution environment, object code may include references resolved by a linker and/or may include one or more unresolved references. The context in which this term is used will make clear the state of the object code when it is relevant. This definition can include machine code and virtual machine code, such as Java™ byte code. As used herein, the terms “application”, and “service” may be realized in one or more executables and/or in one or more hardware components. The terms are used interchangeably herein.

As used herein, the term “network protocol” refers to a formal set of rules, conventions and data structures that governs how computers and other network devices exchange information over a network. The rules, conventions, and data structures are said to be specified or defined in a specification and/or schema.

An “interaction”, as the term is used herein, refers to any activity including a user and an object where the object is a source of sensory data detected by the user. In an interaction the user directs attention to the object. An interaction may also include the object as a target of input from the user. The input from the user may be provided intentionally or unintentionally by the user. For example, a rock being held in the hand of a user is a target of input, both tactile and energy input, from the user. A portable electronic device is a type of object. In another example, a user looking at a portable electronic device is receiving sensory data from the portable electronic device whether the device is presenting an output via an output device or not. The user manipulating an input component of the portable electronic device exemplifies the device, as an input target, receiving input from the user. Note that the user in providing input is detecting sensory information from the portable electronic device provided that the user directs sufficient attention to be aware of the sensory information and provided that no disabilities prevent the user from processing the sensory information. An interaction may include an input from the user that is detected and/or otherwise sensed by the device. An interaction may include sensory information that is detected by a user included in the interaction that is presented by an output device included in the interaction.

As used herein “interaction information” refers to any information that identifies an interaction and/or otherwise provides data about an interaction between a user and an object, such as a portable electronic device. Exemplary interaction information may identify a user input for the object, a user-detectable output presented by an output device of the object, a user-detectable attribute of the object, an operation performed by the object in response to a user, an operation performed by the object to present and/or otherwise produce a user-detectable output, and/or a measure of interaction. The term “operational component” of a device, as used herein, refers to a component included in performing an operation by the device.

Interaction information for one object may include and/or otherwise identify interaction information for another object. For example, a motion detector may detect user's head turn in the direction of a display of a portable electronic device. Interaction information identifying the user's head is facing the display may be received and/or used as interaction information for the portable electronic device indicating the user is receiving visual input from the display. The interaction information may serve to indicate a lack of user interaction with one or more other objects in directions from the user different than the detected direction, such as a person approaching the user from behind the user. Thus the interaction information may serve as interaction information for one or more different objects.

The term “attention information” as used herein refers to information that identifies an attention output and/or that includes an indication to present an attention output. Attention information may identify and/or may include presentation information that includes a representation of an attention output, in one aspect. In another aspect, attention output may include a request and/or one or more instructions for processing by a processor to present an attention output. The aspects described serve merely as examples based on the definition of attention information, and do not provide an exhaustive list of suitable forms and content of attention information.

As used herein the term “attention criterion” refers to a criterion that when met is defined as indicating that interaction between a user and an object is or maybe inadequate at a particular time and/or during a particular time period. In other words, the user is not directing adequate attention to the object.

As used herein, the term “tag” refers to a character string, which may include one or more words, which may be associated with a resource to create an association between the resource and another resource also tagged with the tag. Tags are often used in sharing media, social bookmarking, social news and blog entries to help users search for associated content. In some contexts, the term “tagging” as used herein refers to the process of associating a tag with a resource that can be tagged. As used herein, the term “tagged association” refers to an association that identifies a tag and a resource that is tagged with the tag. A resource is said to be “tagged” with a tag when a tagging process, also referred to as “tagging”, has successfully created a tagged association. In other contexts, a “tagging” refers to a tagged association.

The term “matched tag”, as used herein, refers to an association that identifies a tag and a tagging criterion, where the tagging criterion is based on data other than the tag. The tagging criterion may be based additionally on the tag. The term “tagging association”, as used herein, refers to a matched tag represented in a memory, either persistent and/or volatile. For example, a tagging association may be realized as a record that includes and/or identifies a tag and a tagging criterion. The terms “matched tag” and “tagging association” are used interchangeably. When the term “matched tag” refers to something other than its tagging association, it will be made clear. For example, a reference to matched tag presented in a user interface clearly identifies a UI element that identifies and/or otherwise represents and/or otherwise identifies a matched tag either realized or to be realized in a tagging association. A tagged association, defined above, may identify a matched tag and a resource that is tagged with the tag identified by the matched tag. Such an association is also referred to herein as a “matched tag association”. A resource may be tagged with a matched tag when a tagging criterion identified by the matched tag is met for the resource.

As user herein, the term “vocabulary” refers to a set of valid values that can be assigned to and/or included in a data element. With respect to a tag, a vocabulary defines valid tags. A vocabulary may be specified by one or more rules and/or by identifying one or more valid values directly and/or indirectly.

As used herein, the term “dictionary” refers a vocabulary wherein one or more terms in the vocabulary is assigned a definition. A “definition” as the term is used herein refers to information that identifies semantic information about a data value, such as at tag. Semantic information may include one or more of a textual description of a meaning of the term, an audio description, a visual description, and information identifying a use or context for the term. A use and/or context may be identified, for example, by identifying a part of speech, a dialect or language, an antonym, a synonym, and/or an example usage of the defined data value.

As used herein, any reference to an entity “in” an association is equivalent to describing the object as “identified” by the association, unless explicitly indicated otherwise.

As used herein, the term “communication” refers to information including a message sent and/or for sending via a network between communicants. A message may include text data, audio data, and/or image data. The term “communicant” as used herein refers to a user included in a communication as a sender and/or a receiver of the information. A communicant is represented by a “communications agent” configured to operate in an execution environment to send data to and/or receive data from another communications agent, on behalf of the represented communicant, according to a communications protocol via network. A communications protocol defines and/or otherwise identifies an address space including communications addresses for delivering data sent in a communication from one communications agent to another. A communications protocol is a type of network protocol.

The term “communicant alias” as used herein refers to an identifier of a communicant in a communication where the communicant alias is not a communications address included in an address space of a communications protocol for sending and/or receiving data in the communication.

The term “attachment” as used herein refers to a portion of a communication that includes data from one communicant to another other than data in the message portion. A resource sent as an attachment is data that is typically not presented “inline” or in a message included in a message portion of a communication. Email attachments are perhaps the most widely known attachments included in communications. An email attachment is a file or other resource sent along with an email in a portion of the email separate from a message portion. A communication may include one or more resources as one or more attachments.

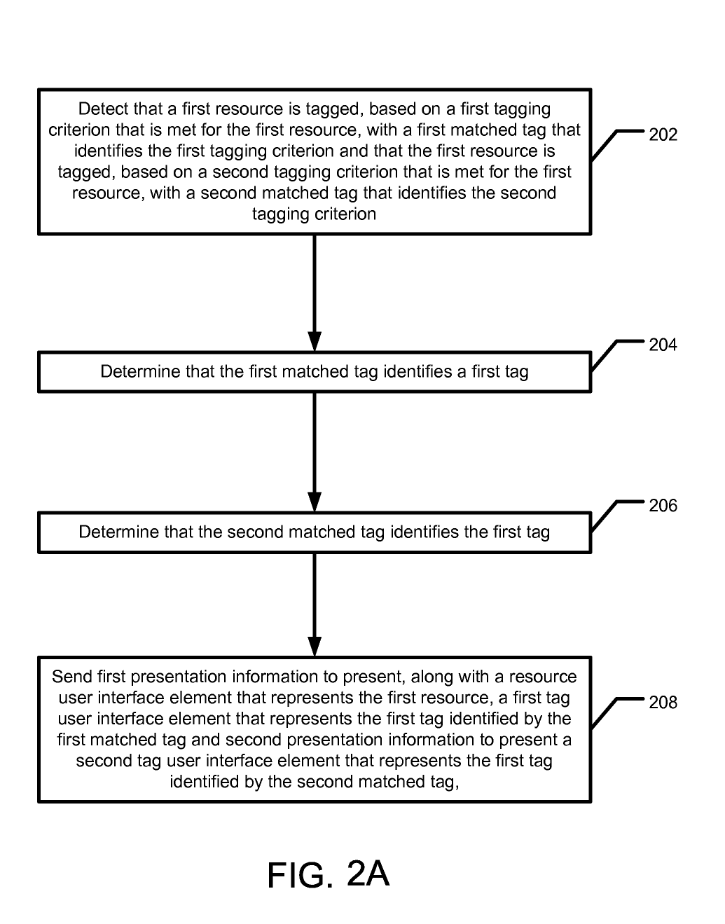

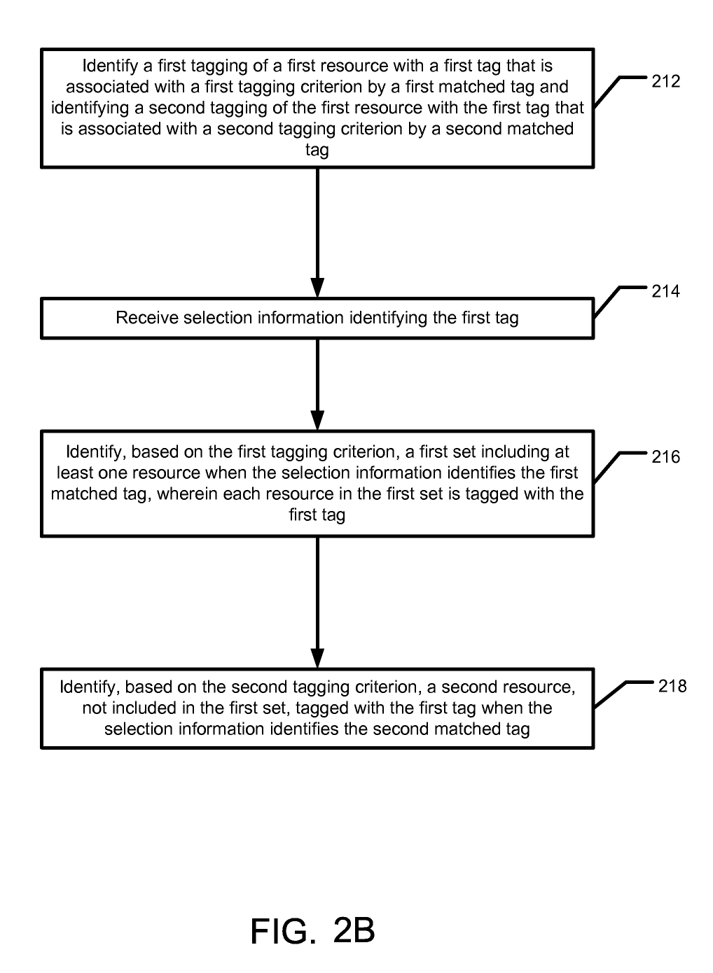

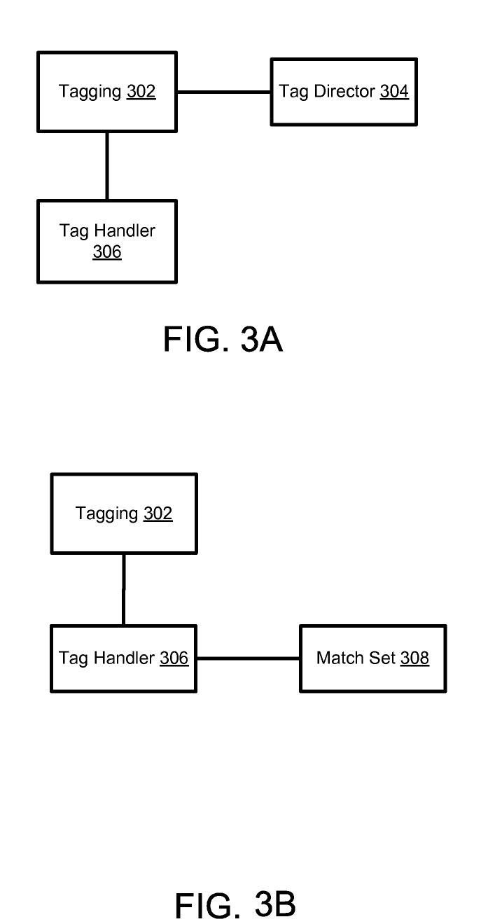

FIG. 3A illustrates an arrangement of components in a system that operates in an execution environment, such as execution environment 102 in FIG. 1. The arrangement of components in the system operates to perform the method illustrated in FIG. 2A. The system illustrated includes a tagging component 302, a tag director component 304, and a tag handler component 306. A suitable execution environment includes a processor, such as processor 104, to process an instruction in at least one of a tagging component, a tag director component, and a tag handler component. FIG. 3B illustrates an arrangement of components in a system that operates to perform the method illustrated in FIG. 2B. The system illustrated includes a tagging component 302, a tag handler component 306, and a match set component 308. A suitable execution environment includes a processor, such as processor 104, to process an instruction in at least one of a tagging component, a tag handler component, and a match set component.

Some components, illustrated in the drawings are identified by numbers with an alphanumeric suffix. A component may be referred to generically in the singular or the plural by dropping a suffix of a portion thereof of the component's identifier. For example, execution environments; such as execution environment 401a, execution environment 401b, execution environment 401c, execution environment 401d, and their adaptations and analogs; are referred to herein generically as an execution environment 401 or execution environments 401 when describing more than one. Other components identified with an alphanumeric suffix may be referred to generically or as a group in a similar manner.

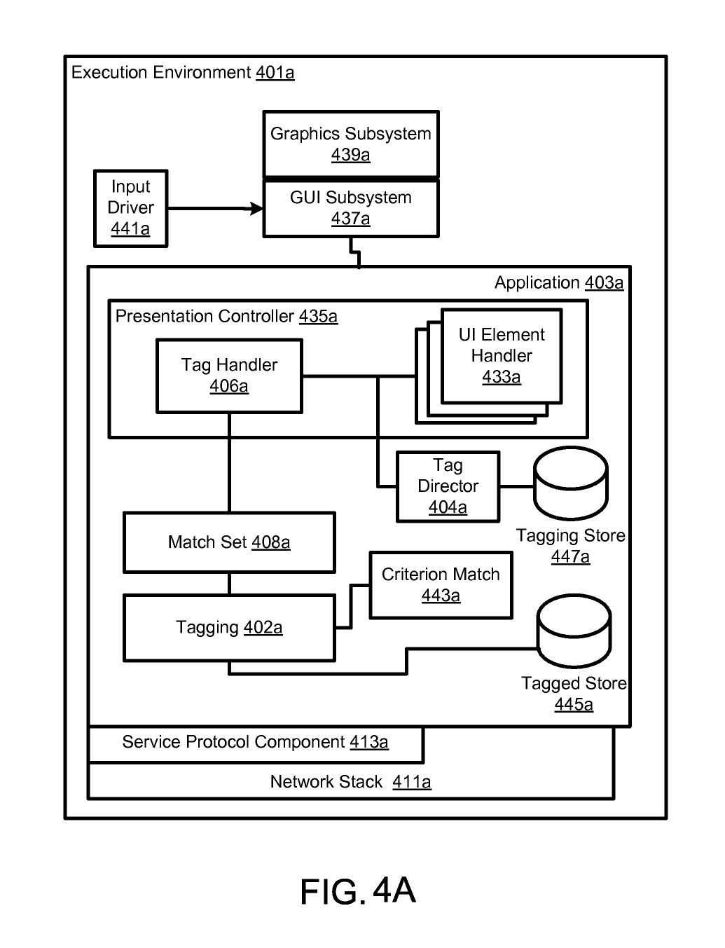

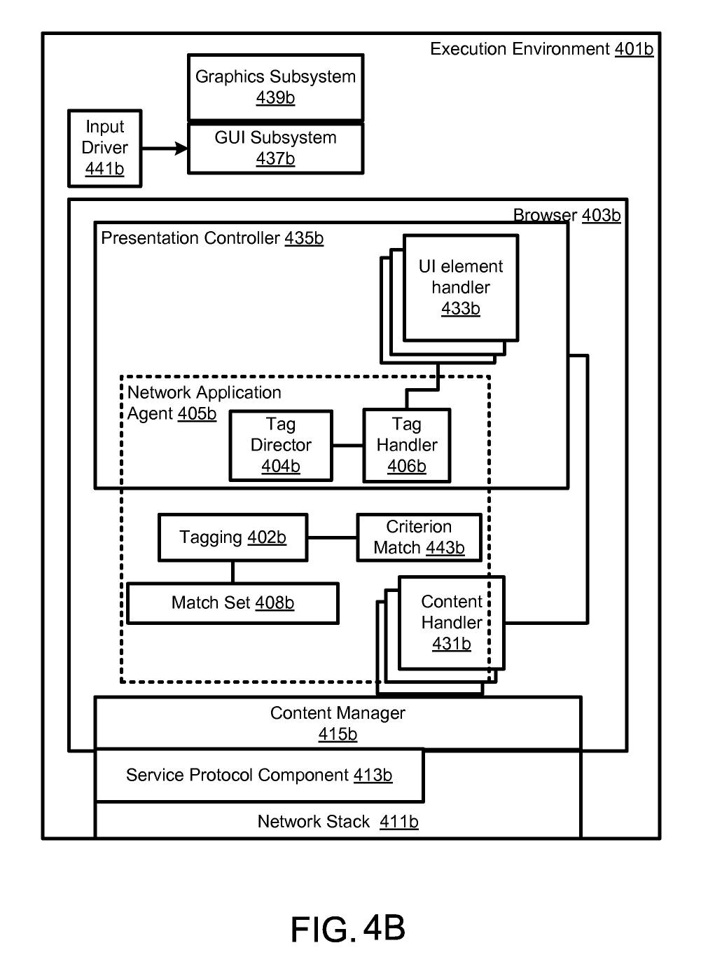

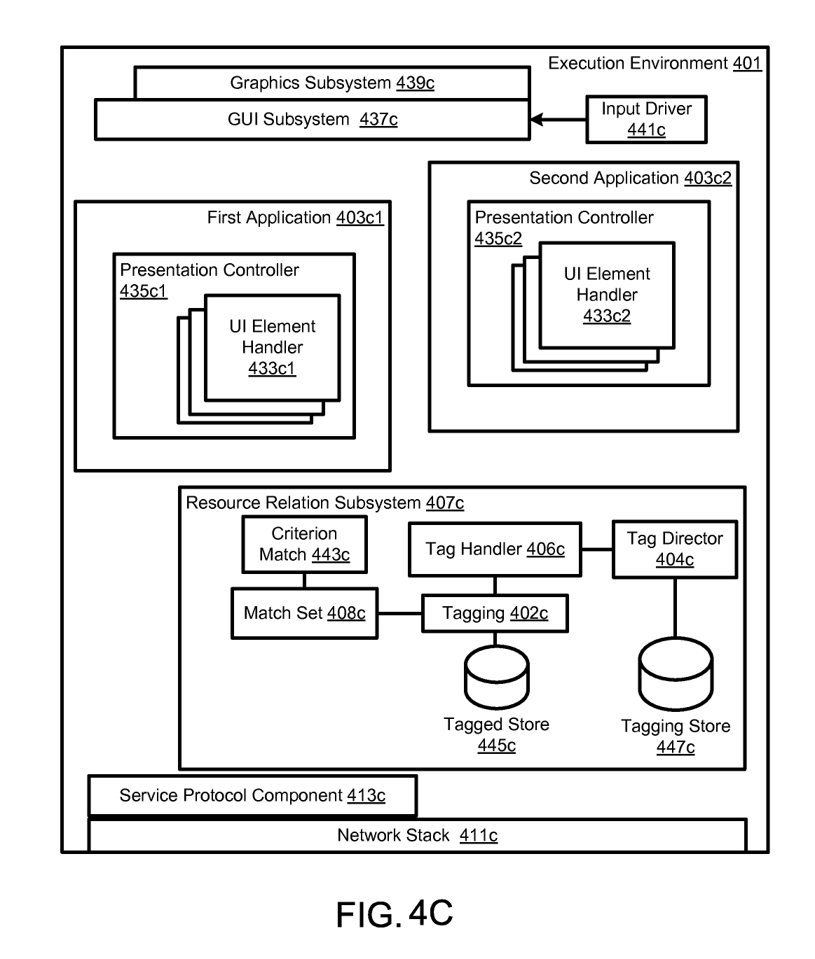

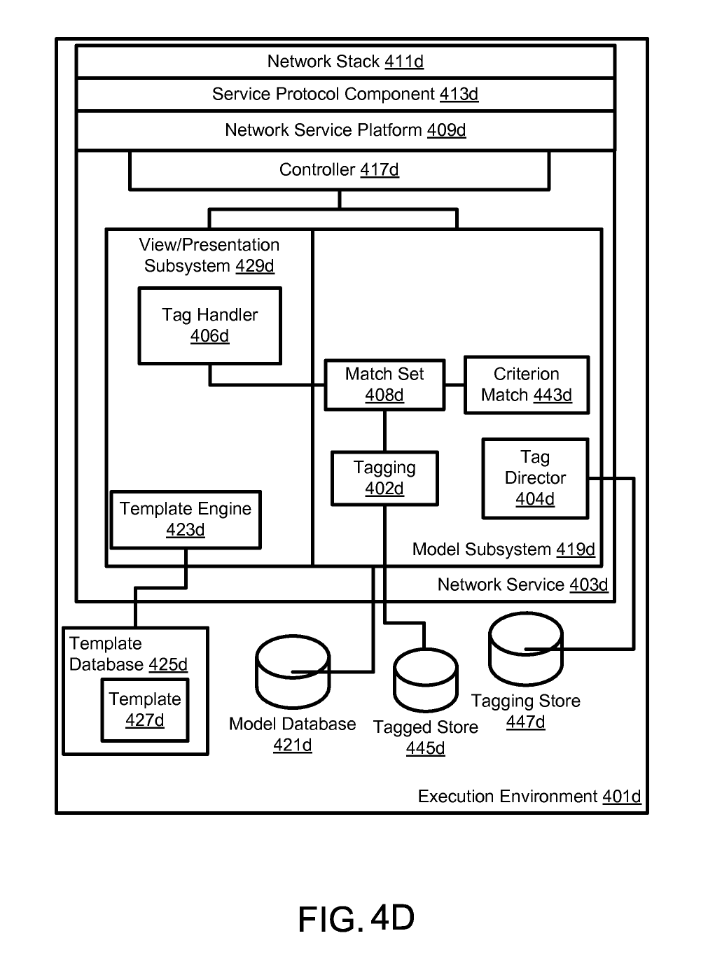

Some or all of the exemplary components illustrated in FIG. 3A may be adapted to operate in a number of execution environments to perform the method illustrated in FIG. 2A. Some or all of the exemplary components illustrated in FIG. 3B may be adapted to operate in a number of execution environments to perform the method illustrated in FIG. 2B. FIGS. 4A-D are each block diagrams illustrating the components of FIG. 3A-B and/or analogs of the components of FIG. 3A-B respectively adapted to operate in an execution environment 401a, an execution environment 401b, an execution environment 401c, and an execution environment 401d that each include and/or otherwise are provided by one or more nodes. FIG. 1 illustrates key components of an exemplary device that may at least partially provide and/or otherwise be included in an execution environment. The components illustrated in FIGS. 4A-D may be included in or otherwise combined with the components of FIG. 1 to create a variety of arrangements of components according to the subject matter described herein.

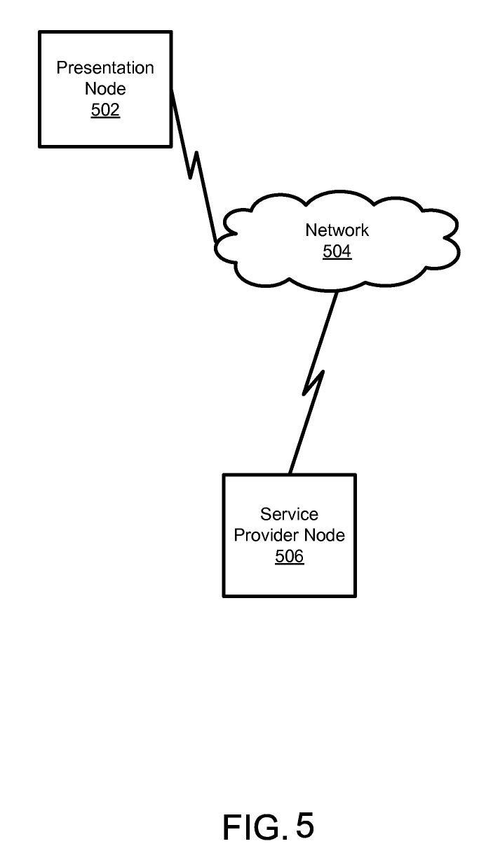

FIG. 5 illustrates a user node 502 as an exemplary device that in various aspects may be included in and/or otherwise adapted to provide any execution environment 401 illustrated in FIGS. 4A-C each illustrating a different adaptation of the arrangement of components in FIG. 3A and the arrangement of component is FIG. 3B. In an aspect, a user node may be included in and/or otherwise may host an execution environment 401d and/or an analog of execution environment 401d. As illustrated in FIG. 5, user node 502 is operatively coupled to a network 504 via a network interface component, such as network interface adapter 114. A server device is illustrated by a service provider node 506. Service provider node 506 may be included in and/or otherwise provide execution environment 401d illustrated in FIG. 4D and/or an analog of execution environment 401d. In an aspect, a service provider node may be included in and/or otherwise may host any execution environment 401 and/or an analog of any execution environment 401 illustrated in FIGS. 4A-C. As illustrated in FIG. 5, service provider node 506 is operatively coupled to network 504 via a network interface component included in execution environment 401d. Thus, service provider node 506 is communicatively coupled to one or more user nodes and/or other service provider nodes. Alternatively or additionally, an adaptation of an execution environment 401 may include and/or may otherwise be provided by a device that is not operatively coupled to a network.

FIG. 4A illustrates that execution environment 401a hosts an application 403a that includes an adaptation of the arrangement of components in FIG. 3A and an adaptation of the arrangement of components in FIG. 3B. FIG. 4B illustrates execution environment 401b hosting a browser 403b including an adaptation of the arrangement of components in FIG. 3A and an adaptation of the arrangement of components in FIG. 3B that each may operate at least partially in a network application agent 405b received from a remote application provider, such as a network service 403d in FIG. 4D. Browser 403b and execution environment 401b may provide at least part of an execution environment for network application agent 405b that may be received via network 504 from network service 403d operating in service provider node 506. FIG. 4C illustrates an arrangement of the components in FIG. 3A and an arrangement of components in FIG. 3B adapted to operate in a tagging subsystem 407c of execution environment 401c.

FIG. 4D illustrates execution environment 401d hosting one or more network services, such as a web application, illustrated by network service 403d. FIG. 4D also illustrates a network service platform 409d that may provide services to one or more network services. Network service 403d includes yet another adaptation of the arrangement of components in FIG. 3A and an adaptation of the arrangement of components in FIG. 3B.

As stated the various adaptations of the arrangement in FIG. 3A-B are not exhaustive. For example, those skilled in the art will see based on the description herein that arrangements of components for performing the method illustrated in FIG. 2A and/or that arrangements of components for performing the method illustrated in FIG. 2B may operate in a single device, or may be distributed across more than one node in a network and/or more than one execution environment. For example, such an arrangement or arrangements may operate at least partially in browser 403b illustrated in FIG. 4B and at least partially in execution environment 401d in and/or external to network service 403d.

FIGS. 4A-D illustrate network stacks 411 that operate to send and receive data over network 504, via a network interface component. Network service platform 409d in FIG. 4D provides services to one or more network services. In various aspects, network service platform 409d may include and/or interoperate with a web server. FIG. 4D also illustrates network service platform 409d that interoperates with a network stack 411d.

Communicating network stacks 411 may support the same protocol suite, such as TCP/IP, or may communicate via a network gateway or other protocol translation device and/or service. For example, browser 403b in FIG. 4B and network service platform 409d in FIG. 4D may interoperate via their respective network stacks: a network stack 411b and network stack 411d.

FIGS. 4A-D illustrate applications 403, respectively, which may communicate via one or more service protocols. FIGS. 4A-D respectively illustrate service protocol components 413 that operate to communicate via one or more service protocols. Exemplary service protocols include hypertext transfer protocol (HTTP), remote procedure call (RPC) protocols, instant messaging protocols, and presence protocols. Matching protocols enabling applications 403 to communicate via network 504 in FIG. 5 are not required, if communication is via a protocol gateway or other translator.

FIG. 4B illustrates that a browser may receive some or all of a network application agent in one or more messages sent from a network service, such as network service 403d, via a network service platform 409, a network stack 411, a network interface component, and optionally a service protocol component 413. In FIG. 4B, browser 403b includes a content manager component 415b. Content manager component 415b may interoperate with one or more of service protocol components 413b and/or network stack 411b to receive the message or messages including some or all of a network application agent 405b.

A network application agent 405 may include a web page for presenting a user interface for and/or otherwise based on data from a corresponding network service. The web page may include and/or reference data represented in one or more formats including hypertext markup language (HTML) and/or other markup language, ECMAScript or other scripting language, byte code, image data, audio data, and/or machine code.

In an example, in response to a request received from browser 403b, a controller component 417d, in FIG. 4D, may invoke a model subsystem 419d to perform request-specific processing. Model subsystem 419d may include any number of request handlers (not shown) that operate to dynamically generate data and/or to retrieve data from a model database 421d based on the request. Controller component 417d may further invoke a template engine component 423d to identify one or more templates and/or static data elements to generate a user interface to present a response to the received request. FIG. 4D illustrates a template database 425d including an exemplary template 427d. FIG. 4D illustrates template engine component 425d as a component in a view subsystem 429d that operates to return responses to processed requests in a presentation format suitable for a client, such as browser 403b. View subsystem 429d may provide the presentation information to controller component 417d to send to browser 403b in response to the request received from browser 403b. Some or all of a network application agent may be sent to a browser via a network service platform, as described above.

While the example describes sending some or all of a network application agent in response to a request, network service 403d additionally or alternatively may send some or all of network application agent 405b to browser 403b via one or more asynchronous messages. In an aspect, an asynchronous message may be sent in response to a change detected by network service 403d. Publish-subscribe protocols, such as the presence protocol specified by XMPP-IM, are exemplary protocols for sending messages asynchronously.

The one or more messages including information representing some or all of network application agent 405b illustrated in FIG. 4B may be received by content manager component 415b via one or more of service protocol component(s) 413b and network stack 411b as described above. In FIG. 4B, browser 403b includes one or more content handler components 431b to process received data according to its data type, typically identified by a MIME-type identifier. Exemplary content handler components 431b include a text/html content handler component for processing HTML documents; an application/xmpp-xml content handler component for processing XMPP streams including presence tuples, instant messages, and publish-subscribe data as defined by various XMPP specifications; one or more video content handler components for processing video streams of various types; and still image data content handler components for processing various images types. Content handler components 431b process received data and may provide a representation of the processed data to one or more user interface (UI) element handler components 433b.

UI element handler components 433 are respectively illustrated in presentation controller components 435 in FIGS. 4A-C. A presentation controller component 435 may manage visual, audio, and/or other types of output of its including application 403 as well as receive and route detected user and other inputs to components and extensions of its including application 403. With respect to FIG. 4B, a UI element handler component 433b in various aspects may be adapted to operate at least partially in a content handler component 431b such as a text/html content handler component and/or a script content handler component. Additionally or alternatively, a UI element handler component 433 in an execution environment 401 may operate in and/or as an extension of its including application 403. For example, a plug-in may provide a virtual machine, for a UI element handler component 433 received as a script and/or byte code, that may operate as an extension in an application 403 and/or external to and interoperating with the application 403.

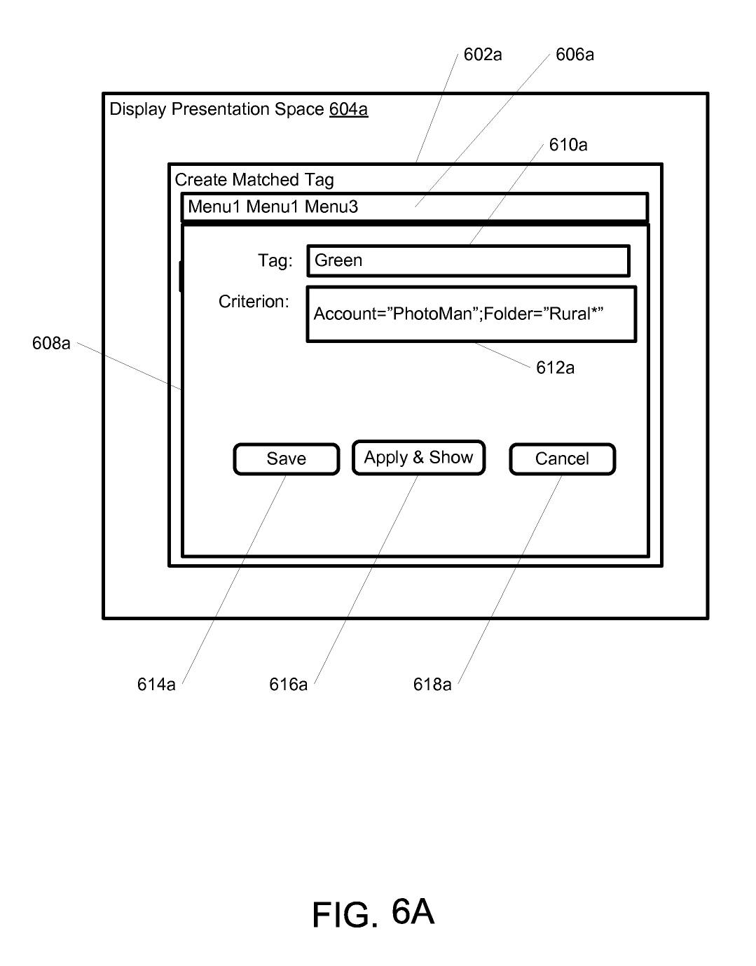

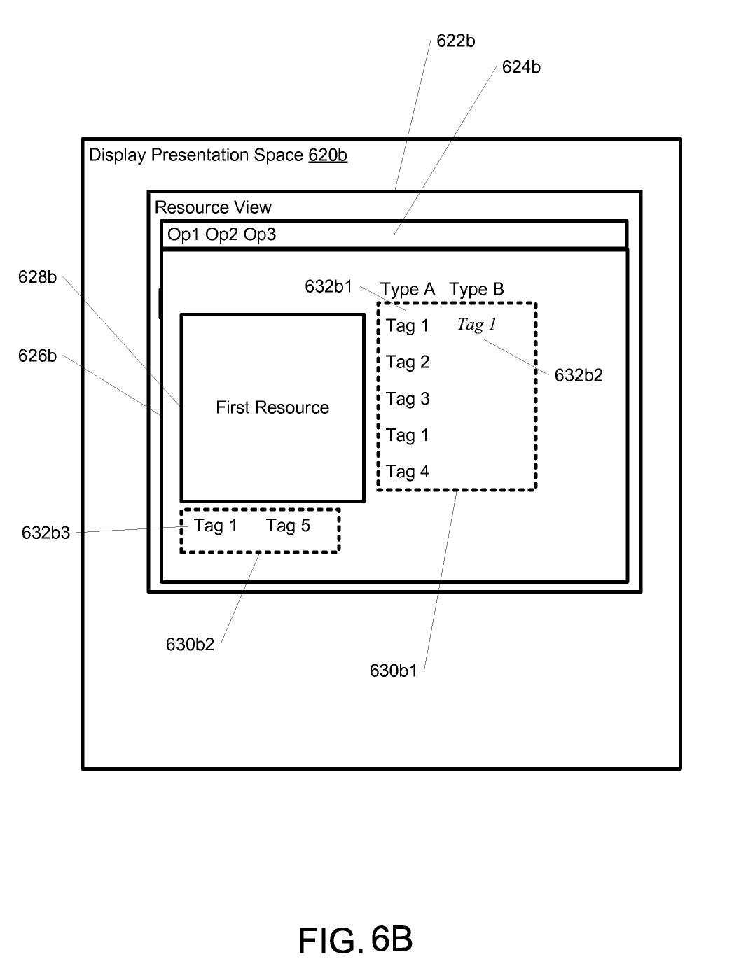

FIGS. 6A-C each respectively illustrates a display presentation space, such as display presentation space 602a in FIG. 6A, of a display in and/or operatively coupled to a node, such as user node 502. An application window is illustrated in each of FIGS. 6A-C, such as a create matched tag UI element 602a in FIG. 6A. An application window is a UI element presented that may provide and/or be included in a user interface for any of applications 403 illustrated in FIGS. 4A-D and/or by a network application agent. For example, create matched tag UI element 602a may be presented via interoperation of browser 403b, network application agent 405b, and/or network service 403d. A browser window may include a user interface of network service 403d operating in service provide node 506.

Various UI elements of applications 403 described above may be presented by one or more UI element handler components 433 in FIGS. 4A-C and/or by view subsystem 429d as illustrated in FIG. 4D. In an aspect, illustrated in FIGS. 4A-C, A UI element handler component 433 of one or more applications 403 may operate to send presentation information representing a UI element, such as any of the visual components in any of the user interfaces illustrated in FIGS. 6A-C, to a GUI subsystem 437. A GUI subsystem 437 may instruct a graphics subsystem 439 to draw, store, and/or otherwise represent the UI element in a region of a display presentation space, based on presentation information received from the corresponding UI element handler component 433.

User input may be received corresponding to a UI element via an input driver 441 illustrated in FIGS. 4A-C in various adaptations. For example, a user may move a mouse to move a pointer presented in a display presentation space 602 over a UI element. A user may provide an input detected by the mouse. The detected input may be received by a GUI subsystem 437 via an input driver 441 as an operation or command indicator based on the association of the shared location of the pointer and the UI element in the display presentation space.

Methods and systems are described for tagging a resource based on a matched tag are described in commonly owned U.S. patent applications: application Ser. No. 13/622,366 (Docket No DRV0002) filed on 2012 Sep. 19, entitled “Methods, Systems, and Program Products for Tagging a Resource”. In one aspect, the method described includes creating a matched tag by associating a user identified tag with a tagging criterion that is based on data other than the tag. The method further includes determining that the tagging criterion is met for each resource in a plurality of resources. The method still further includes tagging the each resource with the tag, in response to the determining. The method additionally includes sending presentation information to present, via an output device, a tag UI element representing the tag for receiving a user input to initiate an operation that identifies a resource in the plurality. Performing at least one the preceding actions comprising the method includes execution of an instruction by a processor. A system described includes one or more processors and logic encoded in one or more tangible media for execution by the one or more processors that when executed is operable for creating a matched tag by associating a user identified tag with a tagging criterion that is based on data other than the tag; determining that the tagging criterion is met for each resource in a plurality of resources; tagging the each resource with the tag, in response to the determining; and sending presentation information to present, via an output device, a tag UI element representing the tag for receiving a user input to initiate an operation that identifies a resource in the plurality. Further, a system for tagging a resource based on a matched tag is described as including a tag director component for creating a matched tag by associating a user identified tag with a tagging criterion that is based on data other than the tag. The system further includes a criterion match component for determining that the tagging criterion is met for each resource in a plurality of resources. The system still further includes a tagging component for tagging the each resource with the tag, in response to the determining. The system yet further includes a tag handler component for sending presentation information to present, via an output device, a tag UI element representing the tag for receiving a user input to initiate an operation that identifies a resource in the plurality. The system also includes a processor, wherein at least one of the tag director component, the criterion match component, the tagging component, and the tag handler component includes an instruction that is executed by the processor during operation of the system.

In various aspects a tag director component 404 may receive tagging information based on input information from a UI element handler component 433. In an aspect, a user input may be detected that corresponds to a UI element presented for identifying a tag. A tag may be a user entered tag and/or otherwise a user selected tag. Further, criterion information identifying a tagging criterion may be received via the same or different UI element handler component 433, where the tagging criterion is based on something other than and/or in addition to the identified tag. In another, aspect, a tagging criterion may be determined based on a user identified tag, by a UI element handler component 433 and/or by a tag director component 404, in response to a user detected input identifying the tag. The tag director component 404 may create a “matched tag” by creating a tagging association that identifies the tag and the tagging criterion. The tag director component 404 may store the tagging association in a tagging store 447.

FIG. 6A depicts a user interface presented by an application 403 as described above for any of FIGS. 4A-D. The application 403 includes one or more UI element handlers 433 to present a create matched tag UI element 602a in a presentation space 604a of a display device. Create matched tag UI element 602a is illustrated with a menu bar 606a including input UI elements for receiving user input for various specified operations. Create matched tag UI element 602a includes an input pane UI element 608a to prompt a user to provide corresponding input to provide tagging information via a tag input UI element 610a. In FIG. 6A, a criterion input UI element 612a is presented by a corresponding UI element handler component 433a allowing corresponding user input that identifies a tagging criterion to be received and/or otherwise detected. The criterion information identifying a tagging criterion is based on data other and/or in addition to the tag identified by the received tagging information.

FIG. 6A illustrates input information “Account=‘PhotoMan;Folder’Rurar”” as criterion information provided by the user. An application 403 may operate to identify “PhotoMan” as a user account identifier The application may identify “Rural” as folder that includes one or more digital photographs. The folder may be a folder shared by multiple accounts. FIG. 6A also illustrates tagging information identifying “Green” as the user identified tag. In an aspect, the user providing the input may be logged in to the application using the “Photoman” account identifier or some other account identifier. The input information may be received by one or more UI element handler components 433 that may be included in and/or may otherwise include a tag handler component 406d that correspond to tag input UI element 610a and criterion input UI element 612a. A tagging component 402 may receive the tagging information and the criterion information in response to a user input targeting a “Save” UI element 614a and/or an “Apply & Show” UI element 616a. The user may cancel providing tagging information and criterion information by directing an input to a “Cancel” UI element 618a. A second tagging criterion that identifies a folder of images of pesticide free fruits may also be associated with the tag “Green”, in one of many examples of tags that may be associated with different tagging criterion in creating multiple matched tags that identify the same tag.

In an aspect, an operation may be performed to determine whether a tagging criterion is met for a resource, in response to detecting an access to the resource and/or otherwise identifying the resource. Detecting an access to and/or otherwise identifying a resource may be direct and/or indirect. Further detecting an access to and/or otherwise identifying a resource may include receiving an identifier of a resource, detecting an indication that a resource is to be accessed, detecting a resource while it is accessed, and/or detecting a resource subsequent to an access to the resource.

With respect to FIGS. 4A-D, an application 403 may access a resource, in response to a request to present a listing of resources in a folder in a file system, data base, and/or other data repository that includes the particular resource. A criterion match component 443 may be invoked, in response to accessing the resource and/or an identifier of the resource. A tag director component 404 may interoperate with the criterion match component 443 to identify a tagging criterion identified by a matched tag. The criterion match component 443 may determine whether the tagging criterion is met for the resource. The tagging criterion is be based on data associated with the resource other than the tag. For example, the tagging criterion may specify a threshold criterion for measuring a playing duration of a video stream. A criterion match component 443 may operate to access video stream play duration information from metadata in and/or otherwise associated with a video file in order to evaluate the tagging criterion. The criterion match component 443 may determine that the tagging criterion is met. This process may be repeated in response to accessing each resource in the identified data repository. A criterion match component 443 may detect that the tagging criterion is met for a plurality of resources. In the playing duration example, described above, the matched tag identifying the tagging criterion may identify the tag “movie” or “feature length”. When the threshold is exceeded, the tagging criterion may be specified to indicate the criterion is met when evaluated for a particular video file.

With respect to FIGS. 4A-D, a criterion match component 443 may determine that a tagging criterion is met for a resource. The criterion match component 443 may invoke, directly and/or indirectly, a tagging component 402 and identify the resource, the tag, and optionally the tagging criterion to the tagging component 402. The tagging component 402 may tag the resource by creating tagged association that identifies the resource and the matched tag.

With reference to FIG. 2A, a block 202 illustrates that the method includes detecting that a first resource is tagged, based on a first tagging criterion that is met for the first resource, with a first matched tag that identifies the first tagging criterion and that the first resource is tagged, based on a second tagging criterion that is met for the first resource, with a second matched tag that identifies the second tagging criterion. Accordingly, a system for identifying a matched tag set includes means for detecting that a first resource is tagged, based on a first tagging criterion that is met for the first resource, with a first matched tag that identifies the first tagging criterion and that the first resource is tagged, based on a second tagging criterion that is met for the first resource, with a second matched tag that identifies the second tagging criterion. For example, the arrangement in FIG. 3A, includes tagging component 302 that is operable for detecting that a first resource is tagged, based on a first tagging criterion that is met for the first resource, with a first matched tag that identifies the first tagging criterion and that the first resource is tagged, based on a second tagging criterion that is met for the first resource, with a second matched tag that identifies the second tagging criterion. FIGS. 4A-D illustrate tagging components 402 as adaptations and/or analogs of the tagging component 302 in FIG. 3. One or more tagging components 402 operate in an execution environment 401. The system for identifying a matched tag set includes one or more processors and logic encoded in one or more tangible media for execution by the one or more processors that when executed is operable for detecting that a first resource is tagged, based on a first tagging criterion that is met for the first resource, with a first matched tag that identifies the first tagging criterion and that the first resource is tagged, based on a second tagging criterion that is met for the first resource, with a second matched tag that identifies the second tagging criterion.

In FIG. 4A, a tagging component 402a is illustrated as a component of application 403a. In FIG. 4B, a tagging component 402b is illustrated as a component of network application agent 405b. In FIG. 4C, a tagging component 402c is illustrated operating external to one or more applications 403c. Execution environment 401c includes a tagging component 402c in a tagging subsystem 407c. In FIG. 4D, a tagging component 402d is illustrated operating in network service 403d remote from a network agent communicatively coupled to the network service 403d. In an aspect tagging component 402b and tagging component 402d communicate via browser 403b and network service 403d in performing a portion of the method illustrated in FIG. 2A in block 202.

With respect to FIG. 4A-D, an application 403 may access and/or otherwise identify a resource. The application 403 may invoke a tagging component 402 to identify, create, and/or otherwise determine one or more matched tags with which the resource is currently or will be tagged. A tagging component 402 may operate to tag a resource with a matched tag, as described above. In tagging a resource with a matched tag, the tagging component 402 may detect that the resource is tagged with matched tag. A tagging component 402 may, alternatively or additionally, maintain a matched tag for a resource via a tagged association that identifies the matched tag and the resource that is tagged by the matched tag. A resource that is tagged with a matched tag is tagged with the tag identified by the matched tag. Maintaining a tagged association may include creating, deleting, modifying, and/or otherwise accessing the tagged association.

In an aspect and referring to FIG. 4A, tagging component 402a may detect a matched tag that tags a particular resource by creating a tagged association that identifies, directly and/or indirectly, the matched tag and the resource. Tagging component 402a may automatically detect that a resource is tagged with a matched tag by tagging the resource with the tag. The resource may be tagged automatically in response criterion match component 443a determining that a tagging criterion in the matched tag is met for the resource. With respect to FIG. 4A when criterion match component 443a determines that a tagging criterion, in a matched tag, is met for a resource, criterion match component 443a may invoke, directly and/or indirectly, tagging component 402a identifying the resource and the matched tag. Tagging component 402a may create a tagged association to tag the resource with the matched tag. The tagged association may be stored in a persistent data store, such as tagged store 445a. When the resource is accessed again, tagging component 402a may be invoked to detect that the resource is tagged with the matched tag identified by the tagged association.

A tagged association may be stored in a processor memory for a duration of a particular task, such as the presentation of the resource and the tag. When the presentation ends, the tagged association may be deleted and/or otherwise destroyed by tagging component 402a. When the resource is accessed again, criterion match component 443a may be invoked again to determine whether the tagging criterion is met for the resource. If the data that the tagging criterion is based on has changed, the tagging criterion might not be met, for the resource. If the tagging criterion is met, criterion match component 443a may again invoke tagging component 402a to once again tag the resource and, thus, detect that the resource is tagged with the matched tag.

Referring to FIG. 4B, detecting that a resource is tagged with a matched tag may be performed by tagging component 402b automatically in response to the creation of a matched tag, by tag director component 404b, as described above. Thus, tagging may be performed automatically in response to identifying that a tagging criterion in the matched tag is met for a resource. Tagging component 402b, in browser 403b in an execution environment 401b of a user node 502, may be invoked in response to criterion match component 443b and/or criterion match component 443d, in an execution environment 401d of a service provider node 506. Tagging component 402b may determine that the tagging criterion, identified by the matched tag, is met for the resource. Tagging component 402b may create and/or otherwise identify a tagged association that tags the resource with the matched tag. Tagging component 402b may interoperate with tagging component 402d in execution environment 401d of service provider node 506 via network 504, to create and/or otherwise identify the tagged association. The tagged association may be stored in a storage medium by one or both of user node 502 and service provider node 506. As described above, a tagged association may be stored in a volatile data storage medium and/or in a persistent data storage medium, such as tagged store 445d. Tagging component 402b may determine and/or otherwise detect that a resource is tagged with a matched tag by processing one or more stored tagged associations in a local tagged store (not shown) and/or retrieved from tagged store 445d in execution environment 401d of service provider node 506.

With respect to FIG. 4D, tagging component 402d is illustrated operating in model subsystem 419d in an execution environment 401d, which may be included in and/or otherwise may include a service provider node 506 in FIG. 5 as previously described. Criterion match component 443d may determine that a tagging criterion identified by a matched tag is met for a particular resource, as described above. Tagging component 402d may automatically tag the resource, in response to determining that the tagging criterion is met. Alternatively or additionally, criterion match component 443b in an execution environment 401b of a user node 502 may determine that the tagging criterion is met for the resource. A message may be sent from user node 502 via network 504 to service provider node 506 to automatically invoke tagging component 402d to tag the resource with the tag identified by the matched tag and, thus, detect that the resource is tagged with the matched tag. Tagging component 402d operating in execution environment 401d of service provider node 506 may be invoked in response to the message via a request handler (not shown) in model subsystem 419d. Tagging component 402d may create a tagged association stored in tagged store 445d and/or may interoperate with tagging component 402b to create the tagged association, a copy of the tagged association, and/or a reference to the tagged association stored in a data storage medium of user node 502.

The arrangement of components in execution environment 401c, may perform the same or analogous operations as the other arrangements described above with respect to detecting that a resource is tagged with a matched tag. In FIG. 4A-D, tagging may be performed automatically. In FIG. 4C, tagging component 402c, in tagging subsystem 407c, may be invoked to tag a resource and/or otherwise detect that the resource is tagged with a matched tag. In an aspect, tagging component 402c may receive a matched tag via and/or otherwise identify the match tag in response to being invoked. Tagging component 402c may create a tagged association, thus tagging the resource with the matched tag. The tagged association may be stored in tagged store 445c accessible to multiple applications 403c operating in execution environment 401c. One or more tagged resources may be shared between and/or among applications 403c and/or one or more tagged resources and/or tags may be accessible only to a particular application 403c. Tagging subsystem 407c may operate to control sharing of resources, tagging criterion, tags, and/or matched tags between and/or among applications 403c. The arrangement of components illustrated in FIG. 4D, may analogously be configured to control sharing of resources, tagging criterion, tags, and/or matched tags between and/or among user nodes communicatively coupled to a service provider node providing and/or part of execution environment 401d.

Returning to FIG. 2A, a block 204 illustrates that the method further includes determining that the first matched tag identifies a first tag. Accordingly, a system for identifying a matched tag set includes means for determining that the first matched tag identifies a first tag. For example, the arrangement in FIG. 3A, includes tag director component 304 that is operable for determining that the first matched tag identifies a first tag. FIGS. 4A-D illustrate tag director components 404 as adaptations and/or analogs of tag director component 304 in FIG. 3. One or more tag director components 404 operate in an execution environment 401. The system for identifying a matched tag set includes one or more processors and logic encoded in one or more tangible media for execution by the one or more processors that when executed is operable for determining that the first matched tag identifies a first tag.

In FIG. 2A, a block 206 illustrates that the method yet further includes determining that the second matched tag identifies the first tag. Accordingly, a system for identifying a matched tag set includes means for determining that the second matched tag identifies the first tag. For example, the arrangement in FIG. 3A, includes tag director component 304 that is operable for determining that the second matched tag identifies the first tag. FIGS. 4A-D illustrate tag director components 404 as adaptations and/or analogs of tag director component 304 in FIG. 3. One or more tag director components 404 operate in an execution environment 401. The system for identifying a matched tag set includes one or more processors and logic encoded in one or more tangible media for execution by the one or more processors that when executed is operable for determining that the second matched tag identifies the first tag

In FIG. 4A, a tag director component 404a is illustrated as a component of application 403a. In FIG. 4B, a tag director component 404b is illustrated as a component of network application agent 405b. In FIG. 4C, a tag director component 402c is illustrated operating external to one or more applications 403c. Execution environment 401c includes a tag director component 404c in tagging subsystem 407c. In FIG. 4D, a tag director component 404d is illustrated operating in network service 403d remote from a network agent communicatively coupled to the network service 403d. In an aspect tag director component 404b and tag director component 404d communicate via browser 403b and network service 403d in performing a portion of the method illustrated in FIG. 2A in block 204 and in block 206.

With respect to FIGS. 4A-D, a tag director component 404 may determine, for a matched tag, a tag and a tagging criterion identified by the tagging association that instantiates and/or otherwise realizes the matched tag. An application 403 in an execution environment 401 may invoke a tag director component 402 accessible via the execution environment 401. The tag director component 404 may create, delete, modify, maintain, and otherwise access tagging associations that represent and/or otherwise identify respective matched tags in a tagging store 447. One or more tags may each be included in one or more matched tags. Each matched tag identifies a tagging criterion. A first resource, such as a first image of organically grown lettuce, may be tagged with a first tag, such as “green”. A tag director component 402 may locate more than one tagging associations that identifies the first tag in the tagging store 447. The tag director component 402 may interoperate with a tagging component 402 to determine whether the resource is tagged with the first tag that is included in and/or otherwise references a particular matched tag, such as first matched tag. Tagging component 402 may further determine how many times the resource is tagged with the first tag included in and/or otherwise referencing a respective matched tag.

For example, in FIG. 4A, tag director component 404a may determine and/or identify a first matched tag and a second matched tag that each identify a first tag, such as “green”. Tag director component 404a may process tagging associations in tagging store 447a, to locate and/or otherwise identify the matched tags. Tagging component 402a may determine that a first resource, such as the first image, is tagged twice with the a first tag. Tagging component 402a may perform the determination before, during, and/or after tag director component 404a identifies a first tagging association for the first matched tag and a second tagging association for the second matched tag. Tagging component 402a and tag director component 404a may interoperate to determine that the first tag, in a first tagging of the first resource, is included in and/or otherwise identifies a first matched tag located by tagging director component 404a. Tagging component 402a and tag director component 404a may interoperate to determine that the first tag, in a second tagging of the first resource, is included in and/or otherwise identifies a second matched tag. The first matched tag associates the first tag with a first tagging criterion where the first tagging criterion is met for the first resource. The second matched tag associates the first tag with a second tagging criterion where the second tagging criterion is met for the first resource. Tag director component 404a may locate the first matched tag and the second matched tag by performing a lookup in tagging store 447a that is based on the first tag, based on an identifier for the first matched tag and/or the second matched tag, and/or based on determining via criterion match 443a that the first tagging criterion is met for the first resource and/or that the second tagging criterion is met for the first resource.

With respect to FIG. 4A-D, in another aspect, a tag director component 404 may interoperate with a tagging component 402 to dynamically tag a resource, in response to accessing and/or otherwise identifying the resource. In FIG. 4B, at the direction of tagging component 402b, tag director component 404b may retrieve and/or identify a first tagging criterion in a first matched tag. The first tagging criterion may be provided to and/or otherwise may be identified to criterion match component 443b, by tag director component 404b and/or by tagging component 402b. Criterion match component 443b may determine that the first tagging criterion is met for the resource. In response, tagging component 402b may operate to tag the resource with the first matched tag that includes the first tagging criterion. The first resource may be similarly tagged with a second matched tag in response to criterion match component 443b determining that a second tagging criterion, identified by the second matched tag, is met. The first matched tag and the second matched tag may each identify an identical first tag.

In another aspect, tagging may be persistent. Tag director component 404b may interoperate with tagging component 402b and/or the criterion match component 443b to ensure that the tags for the resource are correct and/or current at the time a resource is accessed, when an attribute of a resource changes. A change may take place at a scheduled time, and/or in response to a input from a user, to identify a couple of examples. Tag director component 404b may interoperate with network service 403d via a network in performing the described operations. Interoperating with network service 403d may include interoperating with a tag director component 404d in network service 403d.

As described, in response to an access to and/or identification of a resource, the resource may be tagged automatically with a tag in a matched tag where a tagging criterion in the matched tag is met for the resource. In another aspect, a resource may be first tagged with a tag identified by a first matched tag that is included in and/or otherwise is identified in the first tagging, while a second matched tag that identifies the tag is not included in the tagging. The resource may be tagged a second time with the same tag where the second tagging includes the second matched tag not included in the first tagging. Thus, a resource may be first tagged with a tag where the first tagging includes a first matched tag. The resource may be second tagged with the first tag where the second tagging includes a second matched tag. The resource may be tagged with the first tag as many times as there matched tags that identify the first tag and that identify respective tagging criterion that are met for the resource. In some aspects, the resource may be tagged with the first tag where the tagging includes no matched tag and/or where the matched tag identifies a tagging criterion that is always met for all resources.

With respect to FIG. 4A-D, a tag director component 404 may create and otherwise receive a matched tag for storing a tagging association in any suitable way and at any suitable time. A tag director component 404 may interoperate with a tagging component 402 in determining whether a particular resource is tagged with more than one matched tag that identifies a same tag. In FIG. 4C, tagged associations stored in tagged store 445c in records in a file, database, and/or other suitable data storage structure or container. Alternatively or additionally, when a resource is accessed by and/or on behalf of an application 403c, tag director component 404c may interoperate with criterion match component 443c to determine whether any tagging criterion identified by one or more matched tags is met for the resource. More than one tagging criterion may be identified by tag director component 404c that is met for the resource. Each tagging criterion is identified by a respective matched tags that may identify the same tag, For any tagging criterion that are met, tagging component 402c may tag the resource with the matched tag in the tagging in creating a tagged association.

Additionally with respect to FIG. 4A-D, a tagging component 402 interoperating with a tag director component 404 may determine that a resource is tagged with more than one matched tag that each identify the same tag in response to a change to an attribute associated with the resource. Such an attribute may be included in the resource and/or associated with the resource as, for example metadata for the resource.

In FIG. 4D, tagging component 402d may operate, in response to detecting a change in an attribute of a resource, such as an owner attribute, to determine, via interoperation with tag director component 404d to identify a tagging criterion, that is based on the attribute. The tagging criterion may or may not be in a matched tag included in a tagging of the resource. Criterion match component 443d and/or a criterion match component 443b which may be included in a network agent 403b communicatively coupled to network service 403d via a network, may determine whether the tagging criterion is met or is no longer met for the resource, as a result of the changed attribute. When the tagging criterion is met, the resource may be tagged or may remained tagged with the matched tag when included in an existing tagging. When the tagging criterion is not met, the resource may remain without a tagging that includes the matched tag or an existing tagging that includes the match tag may be deleted and/or otherwise removed for the resource by deleting the corresponding tagged association. That is, the resource may be untagged. A newly created attribute and a deleted attribute are considered, herein, to be changes to attributes. In response to a change in an attribute of a resource, the resource may be tagged so that it is tagged with more than one matched tagged that identifies a same tag, the resource may be untagged so that it may not be tagged by more than one matched tag that identifies a same tag, or its taggings may be left unchanged.

Returning to FIG. 2A, a block 208 illustrates that the method yet further includes sending first presentation information to present, along with a resource user interface element that represents the first resource, a first tag user interface element that represents the first tag identified by the first matched tag and second presentation information to present a second tag user interface element that represents the first tag identified by the second matched tag. Accordingly, a system for identifying a matched tag set includes means for sending first presentation information to present, along with a resource user interface element that represents the first resource, a first tag user interface element that represents the first tag identified by the first matched tag and second presentation information to present a second tag user interface element that represents the first tag identified by the second matched tag. For example, the arrangement in FIG. 3A, includes tag handler component 306 that is operable for sending first presentation information to present, along with a resource user interface element that represents the first resource, a first tag user interface element that represents the first tag identified by the first matched tag and second presentation information to present a second tag user interface element that represents the first tag identified by the second matched tag. FIGS. 4A-D illustrate tag handler components 406 as adaptations and/or analogs of tag handler component 306 in FIG. 3. One or more tag handler components 406 operate in an execution environment 401. The system for identifying a matched tag set includes one or more processors and logic encoded in one or more tangible media for execution by the one or more processors that when executed is operable for sending first presentation information to present, along with a resource user interface element that represents the first resource, a first tag user interface element that represents the first tag identified by the first matched tag and second presentation information to present a second tag user interface element that represents the first tag identified by the second matched tag.

In FIG. 4A, a tag handler component 406a is illustrated as a component of application 403a. In FIG. 4B, a tag handler component 406b is illustrated as a component of network application agent 405b. In FIG. 4C, a tag handler component 406c is illustrated operating external to one or more applications 403c. Execution environment 401c includes a tag handler component 406c in tagging subsystem 407c. In FIG. 4D, a tag handler component 406d is illustrated operating in network service 403d remote from a network agent communicatively coupled to the network service 403d. In an aspect tag handler component 406b and tag handler component 406d communicate via browser 403b and network service 403d in performing a portion of the method illustrated in FIG. 2A in block 208.

FIG. 6B illustrates a presentation space 620b of a display device. With respect to FIGS. 4A-D, an application 403 operating in an execution environment 401 may present a resource view UI element 622b via operation of one or more UI element handler components 433. The application 403 may interoperate with a GUI subsystem 437 via a network and/or locally to present resource view UI element 622b and any UI elements it may include. A UI element handler 433b may provide a menu bar UI element 624b including UI elements representing actions and/or operations that may be invoked via detecting a corresponding user input. The same or a different UI element handler component 433 may present a pane UI element 626b in which resource related UI elements may be presented. FIG. 6B illustrates a first resource UI element 628b representing a first resource that may be currently tagged, is being tagged, and/or will be tagged during its presentation. The first resource may include an image, such as the first image of fruit, such as green pear. A tagging component 402 may identify matched tags and/or tags for the first resource. A tag descriptor component 404 may access tagging associations specifying and/or otherwise defining respective matched tags. Application 403 may invoke a tag handler component 406 for the various matched tags and/or tags identified by tagging component 402. The one or more tag handler component(s) 406 may operate to send presentation information to present, along with first resource UI element 628b that represents and/or otherwise identifies the first resource, tag user interface elements illustrated in a first portion 630b1 and in a second portion 630b2 of pane UI element 626b. A first tag identified in a first matched tag, in a second matched tag, and in a third matched tag are represented and/or otherwise identified by a first tag UI element 632b1, a second tag UI element 632b2, and a third tag UI element 632b3.

In FIG. 4A, a request to present a resource may be detected by a UI element handler component 433a of application 403a. Application 403a may access, the resource, in responding to the user request. The UI element handler component 433a may operate to present the resource in a resource UI element. The UI element handler component 433a corresponding to the resource UI element may include and/or otherwise interoperate with tagging component 402a as described above to identify one or more matched tags for the resource. For a tag that tags the resource a first time and a second time, application 403a may invoke a tag handle component 406a to generate first presentation information for the first tag in the first tagging of the resource, where the first tagging includes and/or is otherwise based a first matched tag that identifies the first tag and identifies a first tagging criterion that is met for the resource. The tag handler component(s) 406a sends the first presentation information to present, via an output device along with the resource UI element, a first tag UI element that represents and/or otherwise identifies the first tag with which the first resource is first tagged in the first tagging. Application 403a may invoke the same and/or a different tag handler component 406a to generate second presentation information for the second tagging of the resource, where the second tagging includes and/or is otherwise based a second matched tag that identifies the first tag and identifies a second tagging criterion that is met for the resource. The tag handler component(s) 406a processing the second presentation information may send the second presentation information to present, via an output device along with the resource UI element, a second tag user interface element that represents and/or otherwise identifies the first tag with which the first resource is second tagged in the second tagging.

Returning to FIG. 6A with respect to FIG. 4B and FIG. 4D, a request to present an image may be detected by a UI element handler component 433b of browser 403b. In response to accessing the image, tag director component 402b of browser 403b and/or tag director component 402d may be invoked to provide the tagging criterion identified in criterion information form field 612a to criterion match component 443b and/or criterion match component 443d. Criterion match component 443b and/or criterion match component 443d may access the account owner of the image in determining whether the tagging criterion is met for the image. Criterion match component 4433b and/or criterion match component 443d may determine that the tagging criterion is met for the image when “PhotoMan” is identified as the account userid of the account associated with the image and when the image in a folder that matches the tagging criterion. An image UI element handler component 433b and/or an image UI element handler component 433d may present a representation of the image in first resource UI element 628b in resource view UI element 622b, in FIG. 6B, in a window or tab (not shown) of browser 403b. Network agent 405b and/or network service 403d may also identify a first tag, “Green”, to tag handler component 406b and/or to tag handler component 406d to present a representation of the tag in one or more tag UI elements 632b representing matched tags that identify the first tag received via tag UI element 610a in FIG. 6A. Other tags may be presented as well, in some aspects.

In FIG. 4C, a request to present a resource may be detected by a UI element handler component 433c in application 403c operating in execution environment 401c. The application 403c may identify the resource, in responding to the user request. A UI element handler component 433c in the application 403c may operate to interoperate with GUI subsystem 437c to present UI element. A UI element handler component 433c corresponding to the resource UI element may include and/or otherwise interoperate with tag handler component 406c to present one or more UI elements that represent and/or otherwise identify one or more tags with which the resource is tagged. For a first tag that tags the resource a first time and a second time, first application 403c1 may invoke tag handle component 406c to generate first presentation information for the first tag in a first tagging of the resource, where the first tagging includes and/or is otherwise based a first matched tag that identifies the first tag and identifies a first tagging criterion that is met for the resource. The tag handler component(s) 406c sends the first presentation information to present, via an output device along with the resource UI element, a first tag user interface element that represents and/or otherwise identifies the first tag with which the first resource is first tagged in the first tagging. First application 403c1 may invoke the same and/or a different tag handler component 406c to also generate second presentation information for a second tagging of the resource, where the second tagging includes and/or is otherwise based a second matched tag that identifies the first tag and identifies a second tagging criterion that is met for the resource. The tag handler component(s) 406c processing the second presentation information may send the second presentation information to present, via an output device along with the resource UI element, a second tag user interface element that represents and/or otherwise identifies the first tag with which the first resource is second tagged in the second tagging.

With reference to FIG. 2B, a block 212 illustrates that the method includes identifying a first tagging of a first resource with a first tag that is associated with a first tagging criterion by a first matched tag and identifying a second tagging of the first resource with the first tag that is associated with a second tagging criterion by a second matched tag. Accordingly, a system for identifying a matched tag set includes means for identifying a first tagging of a first resource with a first tag that is associated with a first tagging criterion by a first matched tag and identifying a second tagging of the first resource with the first tag that is associated with a second tagging criterion by a second matched tag. For example, the arrangement in FIG. 3B, includes tagging component 304 that is operable for identifying a first tagging of a first resource with a first tag that is associated with a first tagging criterion by a first matched tag and identifying a second tagging of the first resource with the first tag that is associated with a second tagging criterion by a second matched tag. FIG. 4 illustrates tagging component 404 as an adaptation and/or analog of tagging component 304 in FIG. 3B. One or more tagging components 404 operate in an execution environment 401. The system for distinguishing tags for a resource includes one or more processors and logic encoded in one or more tangible media for execution by the one or more processors that when executed is operable for identifying a first tagging of a first resource with a first tag that is associated with a first tagging criterion by a first matched tag and identifying a second tagging of the first resource with the first tag that is associated with a second tagging criterion by a second matched tag.

As described above, In FIG. 4A, a tagging component 404a is illustrated as a component of application 403a. In FIG. 4B, a tagging component 404b is illustrated as a component of network application agent 405b. In FIG. 4C, a tagging component 404c is illustrated operating external to one or more applications 403c. Execution environment 401c includes a tagging component 404c in tagging subsystem 407c. In FIG. 4D, a tagging component 404d is illustrated operating in network service 403d remote from a network agent communicatively coupled to the network service 403d. In an aspect tagging component 404b and tagging component 404d communicate via browser 403b and network service 403d in performing a portion of the method illustrated in FIG. 2B in block 212.

With respect to FIGS. 4A-D, as described in detail above, an application 403 may access and/or otherwise identify a resource, such as the resource represented and/or otherwise identified by first resource UI element 628b in FIG. 6B. The application 402 via operation of a tagging component 402, that may interoperate with one or more of a tag director component 404 and a criterion match component 443, may identify more than one matched tag that tags the resource where each matched tag identifies a same tag. Each tagged association that defines and/or specifies a tagging of the resource with the tag also identifies a respective tagging criterion that is met for the resource.

Returning to FIG. 2B, a block 214 illustrates that the method further includes receiving selection information identifying the first tag. Accordingly, a system for identifying a matched tag set includes means for receiving selection information identifying the first tag. For example, the arrangement in FIG. 3B, includes tag handler component 306 that is operable for receiving selection information identifying the first tag. FIG. 4 illustrates tag handler component 406 as an adaptation and/or analog of tag handler component 302 in FIG. 3B. One or more tag handler components 406 operate in an execution environment 401. The system for identifying a matched tag set includes one or more processors and logic encoded in one or more tangible media for execution by the one or more processors that when executed is operable for receiving selection information identifying the first tag.

In FIG. 4A, a tag handler component 406a is illustrated as a component of application 403a. In FIG. 4B, a tag handler component 406b is illustrated as a component of network application agent 405b. In FIG. 4C, a tag handler component 406c is illustrated operating external to one or more applications 403c. Execution environment 401c includes a tag handler component 406c in tagging subsystem 407c. In FIG. 4D, a tag handler component 406d is illustrated operating in network service 403d remote from a network agent communicatively coupled to the network service 403d. In an aspect tag handler component 406b and tag handler component 406d communicate via browser 403b and network service 403d in performing a portion of the method illustrated in FIG. 2B in block 214.

In any of execution environments 401 in FIGS. 4A-D, a tag handler component 406 may be invoked, in response to a user input that targets and/or that otherwise corresponds to a tag UI element 632b in FIG. 6B that represents and/or otherwise identifies a first tag identified in a particular matched tag. The tag handler component 406 may determine which tag UI element 632b corresponds to the detected user input.

When first tag UI element 632b1 corresponds to the user input, a first tag handler component 406, in an aspect, may maintain and/or otherwise access data that associates the first UI element to the first matched tag. Alternatively or additionally, a first tag handler component may maintain and/or otherwise access data that associates the corresponding input directly and/or indirectly to the first matched tag. Analogously, when second tag UI element 632b2 corresponds to the user input, a second tag handler component 406 may maintain and/or otherwise access data that associates the second UI element and/or the corresponding input directly and/or indirectly to the second matched tag. Input corresponding to other tag UI elements 632b that represent and/or otherwise identify the first tag may be processed similarly.

A tag handler component 406 may correspond and/or otherwise may be responsive to inputs corresponding to all tag UI elements 632b. When first tag UI element 632b1 corresponds to a detected user input, the tag handler component 406 and/or a GUI subsystem 437 may maintain and/or otherwise access data that associates the first UI element and/or the corresponding input directly and/or indirectly to the first matched tag. Analogously, when second tag UI element 632b2 corresponds to the user input, tag handler component 406 and/or GUI subsystem 437 may maintain and/or otherwise access data that associates the second UI element and/or the corresponding input directly and/or indirectly to the second matched tag. Input corresponding to other tag UI elements 632b that represent and/or otherwise identify the first tag may be processed similarly.

Returning to FIG. 2B, a block 216 illustrates that the method yet further includes identifying, based on the first tagging criterion, a first set including at least one resource when the selection information identifies the first matched tag, wherein each resource in the first set is tagged with the first tag. Accordingly, a system for identifying a matched tag set includes means for identifying, based on the first tagging criterion, a first set including at least one resource when the selection information identifies the first matched tag, wherein each resource in the first set is tagged with the first tag. For example, the arrangement in FIG. 3B, includes match set component 308 that is operable for identifying, based on the first tagging criterion, a first set including at least one resource when the selection information identifies the first matched tag, wherein each resource in the first set is tagged with the first tag. FIG. 4 illustrates match set component 408 as an adaptation and/or analog of match set component 308 in FIG. 3B. One or more match set components 408 operate in an execution environment 401. The system for match set includes one or more processors and logic encoded in one or more tangible media for execution by the one or more processors that when executed is operable for identifying, based on the first tagging criterion, a first set including at least one resource when the selection information identifies the first matched tag, wherein each resource in the first set is tagged with the first tag.

Returning to FIG. 2B, a block 218 illustrates that the method yet further includes identifying, based on the second tagging criterion, a second resource, not included in the first set, tagged with the first tag when the selection information identifies the second matched tag. Accordingly, a system for identifying a matched tag set includes means for identifying, based on the second tagging criterion, a second resource, not included in the first set, tagged with the first tag when the selection information identifies the second matched tag. For example, the arrangement in FIG. 3B, includes match set component 308 that is operable for identifying, based on the second tagging criterion, a second resource, not included in the first set, tagged with the first tag when the selection information identifies the second matched tag. FIG. 4 illustrates match set component 408 as an adaptation and/or analog of match set component 308 in FIG. 3B. One or more match set components 408 operate in an execution environment 401. The system for identifying a matched tag set includes one or more processors and logic encoded in one or more tangible media for execution by the one or more processors that when executed is operable for identifying, based on the second tagging criterion, a second resource, not included in the first set, tagged with the first tag when the selection information identifies the second matched tag. In FIG. 4, a match set component 408 is illustrated as a component of application 403.

In FIG. 4A, a match set component 408a is illustrated as a component of application 403a. In FIG. 4B, a match set component 408b is illustrated as a component of network application agent 405b. In FIG. 4C, a match set component 408c is illustrated operating external to one or more applications 403c. Execution environment 401c includes a match set component 408c in tagging subsystem 407c. In FIG. 4D, a match set component 408d is illustrated operating in network service 403d remote from a network agent communicatively coupled to the network service 403d. In an aspect match set component 408b and match set component 408d communicate via browser 403b and network service 403d in performing a portion of the method illustrated in FIG. 2B in block 216 and in block 218.

As described above, a tag handler component 406 may be invoked, in response to a user input that targets and/or that otherwise corresponds to a tag UI element, representing a first tag, presented by the tag handler component. The tag handler component 406 may process information received in response to the user input as selection information and may identify a particular matched tag also represented and/or otherwise identified by the tag UI element. A match set component 408 may, based on identification of the matched tag by the tag handler component 406, lookup and/or otherwise identify resources tagged with the tag where the tagging criterion, identified by the particular matched tag, is met for each of the resources. Selection information may identify a first tag in a tagged association identifying a first resource and a first matched tag. The first matched tag associates the first tag with a first tagging criterion. Similarly, selection information may identify the first tag in a tagged association identifying the first resource and a second matched tag. The second matched tag associates the first tag with a second tagging criterion. A match set component 406 operates, based on the selection information identifying the first matched tag, to identify resources, tagged with the first tag, for which the first tagging criterion is met. Such resources define a first resource set. The match set component 406 operates, based on the selection information that identifies the second matched tag, to identify resources, tagged with the first tag, for which the second tagging criterion is met, defining a second resource set. In some instances, the first set and the second set may identify equal sets. In other instances, the first set may be subset of the second set and/or the first and second sets may include a non-empty intersection. In still other cases, the first set and the second set my be disjoint meaning their intersection is empty. When the first set and the second set are not equal, at least one of the two sets includes a resource not in the other resource set.

In an aspect, selection information may identify both the first matched tag and the second matched tag. In another aspect, selection information may identify a most recent tagging between the first tagging and the second tagging. The most recent tagging may be detected in response to a removing of one of the first tagging and the second tagging. Selection information may be received in response to a change in an attribute of a resource. The resource may be the first resource.

With reference to FIG. 6B and FIG. 4A, each tag UI element 632b may be presented by a respective tag handler component 406a. Thus user input that corresponds to first tag UI element 632b1 is directed to a corresponding first tag handler component 406a. User input that corresponds to second tag UI element 632b2, in the aspect, is directed to a corresponding second tag handler component 406a. The first tag handler component 406a may include and/or otherwise have access to a parameter that identifies and/or otherwise associates the first matched tag with the first tag UI element 632b1. The second tag handler component 406a may include and/or otherwise have access to a parameter that identifies and/or otherwise associates the second matched tag with the second tag UI element 632b2. In response to a user input corresponding to first tag UI element 632b1, first tag handler component 406a may operate to identify the first matched tag to a match set component 408a. In response to a user input corresponding to second tag UI element 632b2, second tag handler component 406a may operate to identify the second matched tag to match set component 408a. Match set component 408 may process the identified first matched tag to locate and/or otherwise identify one or more resources for which the first tagging criterion identified by the first matched tag is/or has been determined to be met by a criterion match component 443a. The one or more resources are included in a first set. Match set component 408 may process the second tag component to locate and/or otherwise identify a second set of one or more resources for which the second tagging criterion identified by the second matched tag is/or has been determined to be met. The second set may include a resource not included in the first set. In an aspect, the first resource may be included in the first set and in the second set. In another aspect the first resource may be excluded from both sets in which case the first set and the second set may each include zero or more resources. In FIG. 4A, in an aspect, match set component 404a may operate to invoke a search component (not shown) to perform a search based on the tagging criterion in a matched tag to identify the first set and/or the second set.

Tag handler component 406b may operate to process input information from a user. Tag handler component 406b may operate to invoke match set component 408b and/or match set component 408d operating in execution environment 401d of a service provider node 506. The invocation may be direct or indirect. One of the match set components or both of the match set components may locate and/or otherwise identify one or more other resources tagged with an identified tag and stored in a data store of execution environment 401b and/or in a data store of execution environment 401d. In an aspect, tag handler component 408b may interoperate with a content handler component 431b to send a message to network service 403d. The message may include a request for a resource and/or a matched tag that tags the resource identifier. Controller component 417d may route the request to a request handler (not shown) to in model subsystem 419d. The request handler in model subsystem 419d may invoke tag handler component 406d to generate presentation information to present the tag and or the resource. Tag handler component 406d may send the presentation information via controller component 417d in a message to browser 403b. The presentation information in the message may be provided to a suitable content handler component 431b to interoperate with tag handler 406b and/or UI element handler 433b to present a UI element that represents and/or otherwise identifies the matched tag along with a UI element that represents and/or otherwise identifies the resource as described above.

Tag handler component 406c may operate to process input information from a user that corresponds to a UI element that represents and/or otherwise identifies one of the matched tags. Tag handler component 406c may operate to locate another resource tagged with the matched tag via a match set component 408c in tagging subsystem 407c. Alternatively or additionally, match set component 406c may operate to perform a search based on the tagging criterion identified by the matched tag. When the tagging criterion is met for a resource located during the search, the resource may be tagged, if it is not already tagged with the matched tag, as described above via operation of one or more of tag director component 404c, criterion match component 441c, and tagging component 404c. Tagging subsystem 407c may provide services for multiple applications 403c, and in an aspect may allow multiple applications to share tags, matched tags, tagging criterion, and/or resources.

With respect to FIG. 6B, first tag UI element 632b1 may represent and/or otherwise identify the first tag “Green” received via tag field UI element 610a in FIG. 6A, included the first tagging criterion received via tag field UI element 612a that is based on an account identifier and a folder identifier, as described above. Second tag UI element 632b2 may represent and/or otherwise identify the tag “Green” included in a first tagging criterion based on a metadata field for images that identifies a “subject” of the image, such as green plants, green fruit, greenery, Greenland, green houses, green fuels, to name a few examples. A match set component 408 operating in response to a user input targeting first UI element 632b1 locates resources, such as an image of a pear tree, for which the first tagging criterion is met. Such resources are tagged with the first matched tag that identifies the tag “Green” when the first matching criterion is met for each of the resources. The identified resources are associated with the account of user with a user identifier, “Photoman”, and are included in a folder or container named “Rural”. An application 403 including and/or otherwise accessing a match set component 408 may present a user interface element including a list identifying and/or otherwise representing the identified resources via one or more tag handler component 406.

The methods illustrated in FIG. 2A-B may include additional aspects supported by various adaptations and/or analogs of the arrangement of components in FIG. 3A-B. In various aspects,

In an aspect, a first tag user interface element, presented by a tag handler component 406, representing a first matched tag that tags a first resource has a user detectable first attribute, based on the first matched tag. Similarly, a second tag user interface element, presented by a tag handler component 406, representing a second matched tag that tags the first resource has a user detectable second attribute, based the second matched tag. Attributes, based on a matched tag, for a tag UI element that represents and/or otherwise identifies a tag identified by the matched tag include one or more of a font, a label, a color, a size, a shape, a pattern of variation over a specified duration, a location, a type of UI element, and the like. A tag handler component may determine the attribute based on a tagging criterion in a matched tag. The tag handler component may generate presentation information, based on the determined attribute, to send to present a UI element that represents and/or otherwise identifies the matched tag.

A first tag UI element for a first matched tag that identifies a first tag and a second tag UI element for a second matched tag that identifies the first tag may be presented, by a tag handler component, with a user detectable difference based on a difference between the first matched tag and the second matched tag. The user detectable difference may be based on a difference between the first tagging criterion and the second tagging criterion. In an aspect, a difference between the first matching criterion and the second matching criterion may be detected, by a tag handler component, via differences in resources in a first set of resources tagged with the first matched tag and resources in a second set of resources tagged with the second matched tag.

A match set component 408 may operate to locate one or more resources for which a tagging criterion identified by a matched tag has been determined to be met. In an aspect, when a resource is tagged more than once with a particular tag, tag handler component(s) 406 may be invoked by an application 403 to generate presentation information for matched tags that are included in the more than one tagging. The tag handler component 406 may generate different presentation information for each tagging with the tag, so that each UI element that represents and/or otherwise identifies a tagging with the tag that is distinguishable to a user based on one or more user detectable differences between and/or among the tag UI elements that represent and/or otherwise identify the respective taggings with the tag.

With respect to the previous paragraph, presenting a user detectable difference may include identifying, based on the first tagging criterion, a first set of resources tagged with the first tag and identifying, based on the second tagging criterion, a second set of resources tagged with the first tag. A difference between the first set and second set may be detected by a match set component 408. First presentation information for presenting the first tag UI element and second presentation information for presenting the second tag UI element may be sent by one or more tag handler components to present the first UI element and the second UI element with the user detectable difference. Detecting a difference between the first set and the second set may include identifying an intersection set by determining an intersection of the first set and the second set. A match set component may include instructions and/or logic to determine an intersection between two or more sets of resources. An intersection set may be empty or non-empty. When the intersection set is empty, the first set and the second set are disjoint provided one or more of the first set and the second set is non-empty. A particular user detectable difference may be defined and/or otherwise identified to indicate that the first and second sets are disjoint. That is, their intersection is empty. A match set component may include instructions and/or may be provided with information to exclude a particular resource tagged with matched tags corresponding to the resource sets when determining an intersecting set.

When an intersection set is non-empty, the first set and the second set may partially overlap. That is, the intersection set may include one or more, but not all, resources in the first set and may include one or more, but not all, resources in the second set. In another aspect, a non-empty intersection may include the first set and one or more, but not all, resources in the second set. In this case, the first set is a subset of the second set. A non-empty intersection may include the second set and one more, but not all, resources in the first set. In this case, the second set is a subset of the first set. A user detectable difference between first and second tag UI elements respectively representing first and second matched tags, that tag a particular resource, may indicate one of the respective first set and the second set is a subset of the other of the one of the first set and the second set.

In a further aspect, an attribute of a tag UI element representing a matched tag that tags a particular resource may indicate that a set, not including the particular resource, of resources tagged with the matched tag is empty or is not empty. For example a tag UI element may include a user detectable attribute that indicates a count and/or other measure of size of a set of resources tagged with a matched tag represented and/or otherwise identified by the tag UI element. A match set component and/or a tag handler component may determine a count of resources in a set.

In yet another aspect, more than one matched tag that identifies the same tag may identify identical sets of resources identified by a match set component based on respective tagging criterion of the one more matched tags. A first resource may be tagged with a first matched tag and a second matched tag that each identify a first tag. The first matched tag may identify a first tagging criterion and the second matched tag may identify a second matched criterion. Both matched tags may identify a same first tag. A tagging component 402 may detect that the first resource is tagged with both the first matched tag and the second matched tag. The tagging component 402 may determine, based on third tagging criterion that is met for the first resource, with a third matched tag that identifies the third tagging criterion. A tag director component 404 may determine that the first matched tag identifies the same first tag. A match set component 408 may identify, based on the first tagging criterion, a first set of resources tagged with the first tag. The match set component 408 may further identify, based on the third tagging criterion, a third set of resources tagged with the first tag. The first set and the third set may be equal. In an aspect, when the sets are equal, a third tag UI element is not presented, when a first UI element is presented that represents and/or otherwise identifies the same set of resources.

In FIG. 6B, the first resource 628b may be tagged with a first tag, “Green”, a first time represented and/or otherwise identified by a first tag UI element 632b1 and tagged with “Green” a second time represented and/or otherwise identified by second tag UI element 632b2. The instance of first tag, represented and/or otherwise identified by the first tag UI element 632b1, is identified by a first matched tag that identifies a first tagging criterion based on criterion form field 612a in FIG. 6A which is based on a specific user account identifier and a folder identifier. First tag UI element 632b1 is presented with text with a “normal” font attribute, which may be specified to indicate to a user that the scope of the first tag represented and/or otherwise identified by first tag UI element 632b1, as specified by the first tagging criterion, is restricted to a single account. The “Green” tag, represented and/or otherwise identified by second tag UI element 632b2, is identified by the second matched tag that identifies a second tagging criterion that, in this example, does not restrict resources that can be tagged to a single account. Second tag UI element 632b2 is presented with an “italic” font attribute, which may be specified to indicate the scope of the second matched tag spans multiple user accounts. Any additional symbol, character, and/or visual attribute may be defined to distinguish, to a user, matched tags that identify the same tag. A user input corresponding to first tag UI element 632b1 may be processed by a tag handler component and a match set component to identify a first set of resources that are tagged with the first tag via the first tagging criterion. A user input corresponding to second tag UI element 632b2 may be processed by a tag handler component and a match set component to identify a second set of resources that are tagged with the first tag via the second tagging criterion. A second portion 630b2 of pane UI element 626b2 may be specified as a region for presenting matched tags that have empty resource sets when the first resource is excluded. A third tag UI element 632b3 represents and/or otherwise identifies a third matched tag that identifies the first tag and a third matching criterion. A match set component may determine that only the first resource represented and/or otherwise identified by resource UI element 628b is tagged with the third matched tag.

In another aspect, first presentation information may be sent to present a first tag UI element representing a first matched tag identifying a first tag and a first matching criterion. Second presentation information may be sent to present a second tag UI element representing a second matched tag identifying the first tag and a second matching criterion. There may be no user detectable difference between the first UI element and the second UI element other than that they are presented so that each is detectable to a user. Sending presentation information to present the first UI element and the second UI element with no user detectable difference may include identifying, based on the first tagging criterion, a first set of resources tagged with the first tag. A second set of resources, tagged with the first tag, may be identified, based on the second tagging criterion. The first and second presentation information may be sent to present the first tag UI element and the second tag UI element with no user detectable difference when the first set and the second set are equal. No user detectable difference between and/or among tag UI elements that represent and/or otherwise identify the same tag may be defined to indicate to the user that the tags identify the same resources. In another aspect, no user detectable difference between and/or among tag UI elements that represent and/or otherwise identify the same tag may be defined to indicate to the user that the set of resources represented and/or otherwise identified by the tag UI elements is empty.

With respect block 202 in FIG. 2A, detecting that the first resource is tagged with the second matched tag may include determining, based on a second attribute associated with the first resource, that the second tagging criterion is not met for the second resource prior to detecting that the first resource is tagged with the second matched tag. A change to the second attribute may be detected while the resource UI element and the first tag UI element are presented. The change may be detected by a tagging component. In response to detecting the change, a determination and/or a detecting that the second tagging criterion is met for the first resource may be performed. The first resource may be tagged with the second matched tag, in response to detecting the second matching criterion is met. The second presentation information may be sent while the first resource UI element and the first tag UI element continue to be presented, in response detecting the first resource is now tagged with the second matched tag, which occurred as a result of the change. The preceding steps may performed automatically in response to detecting the change.

In another aspect, a change may be detected to an attribute of the first resource. The change may be detected by a tagging component. The change may be detected after the second presentation information has been sent, after determining that the second tagging criterion is met for the first resource. Whether the second tagging criterion is met for the first resource is based on the second attribute, in the aspect. In response to detecting the change, a determination and/or detecting may be performed that indicates the second tagging criterion is not met for the first resource. Presentation information may be sent to indicate that the first resource is no longer tagged with the second matched tag. Presentation information may be sent to remove the second tag UI element from a presentation space of an output device Removing the second tag UI element may be one indication that may be defined to inform a user that the first resource is no longer tagged with the second matched tag. Alternatively or additionally, presentation information may be sent to present a user detectable change to the second tag UI element defined to indicate to the user that the first resource is not tagged with the second matched tag. The second tag UI element may be modified in a manner defined to inform a user that the first resource is no longer tagged with the second matched tag. For example, the second tag UI element may be greyed and disabled as an input UI element. Alternatively or additionally, an action may be associated with the second tag UI element that is invoked in response to an input corresponding to the second tag UI element. The action may present an indication, such as sound or text message, defined to indicate that the first resource is no longer tagged with the second matched tag. After a specified period or in response to a specified event, presentation information may be sent to remove the second tag UI element.

A tag UI element may change; which may include being presented, removed, or modified; based on a change in an attribute associated with a resource. The change may change whether a tagging criterion based on the attribute is met or not for the resource. For example, one or more measures of temperature or humidity may be communicated to a tagging component 402, operating in an execution environment 401, for evaluating a tagging criterion identified by a matched tag. A tag director component 404 may identify and/or otherwise locate the tagging criterion in a tagging association in a tagging store 447. A criterion match component 443 my operate to determine whether the tagging criterion is met for the resource. The tagging criterion may be met based on whether a measure of heat is within a range and/or otherwise meets a threshold condition. The tagging director component 404 may receive and/or otherwise identify a tag associated with the tagging criterion by a tagging association. More specifically, a tagging director component 404 may create a number of matched tags based on various measures of temperature and various respective tags, such as “Normal”, “Alert”, and “Warning”, each identified by a matched tag with a respective matching criterion. Such tags may be used by an application or system that monitors one or more devices which may be located at various locations. Temperature information from the one or more locations may be communicated to a node including and/or otherwise included in an execution environment 401. A criterion match component 443 may be invoked in response to receiving temperature information. Tagging criteria identified by one or more matched tags may also be based on location and/or other information for identifying a particular device or group of devices. In response to receiving temperature information for a location, the criterion match component 443 may locate any resources representing the electronic devices and/or locations to determine whether tagging criterion identified respectively by the one or more of the matched tags is met or is no longer met. In response, to determining that that a tagging criterion is met or no longer met for a resource, a tagging component 402 may be invoked to untag and/or to tag the resource. Note that a user viewing a representation of a monitored device and/or a location may direct input to a tag for the resource to locate other resources with the tag. A user may see via a display that a resource tagged with the tag, “Normal” is untagged with respect to the “Normal” tag and may see an “Alert” tag represented and/or otherwise identified, in response to the resource being tagged with the “Alert” tag. The user may locate one or more other resources tagged with the “Alert” tag by directing an input to the “Alert” UI element and/or an associated UI element. Thus, the present disclosure enables dynamic tagging and untagging in response to changing information. Tagged associations that each identify the same tag updated dynamically

In an aspect, in response to a change in an attribute for a resource, a tag UI element may be automatically presented, a tag UI element may be automatically removed from a presentation, and/or a tag UI element may automatically be modified in a manner that is user detectable.

In a further aspect, a tagging and/or untagging a second resource with one or more matched tags that identify the first tag may effect presentation of tag UI elements for a first resource. The method may method may include identifying a second resource with a third attribute, wherein the whether the second tagging criterion is met for the second resource is based on the third attribute. A change in the second attribute may be detected by a tagging component. When the third resource is not tagged with the second matched tag and in response to the detected change, it may be determined, by a criterion match component, that the second tagging criterion is met for the third resource. The third resource may, as a result, be tagged with the second matched tag by the tagging component. In response to the change and the tagging of the third resource, a tag handler component may send third presentation information to present a user detectable change to at least one of the first tag UI element and the second tag UI element, which are already presented. When the third resource is tagged with the second matched tag and in response to a detected change, it may be determined that the second tagging criterion is no longer met for the third resource. The second matched tag may be removed as a tag of the third resource may, as a result. In response to the change and the untagging of the third resource, third presentation information may be sent to present a user detectable change to at least one of the first tag UI element and the second tag UI element, which are already presented. The third presentation information may be sent to indicate a change to a second set of resources tagged with the second matched tag. The third presentation information may be sent to indicate a change to an intersection of a second set of resources tagged with the second matched tag and a first set of resources tagged with the first matched tag.

In response to the change in the third attribute, the intersection of the first set and the set may be one of an empty set, and a non-empty set. The user detectable change may be specified to indicate the intersection is the empty set. The sets are disjoint. In response to the change in the third attribute, the non-empty set may include a portion of the first set and a portion of the second set. The user detectable change may indicate the intersection is not empty. In response to the change in the third attribute, the intersection may equal one of the first set and the second set. That is one of the sets may be subset of the other and/or the sets may be equal. The user detectable change may indicate one of the first set and the second set is a subset of the other of the one of the first set and the second set.

Examples of resources that may be tagged in various aspects include one or more of text data, image data, audio data, form data, streaming data, a user, a group, a legal entity, an executable program component, a hardware component, a service, and a process.

In still another aspect, a tagging criterion for creating a matched tag may be based on a measure of attention and/or a measure of interaction for the user. Thus various metrics and measures of user interaction and/or the lack of it may be included in a tagging criterion to identify various objects and devices based on user interaction and/or attention to the respective various devices. Resources that represent and/or otherwise identify the various resources and/or user may be tagged with tags bound to tagging criterion by various matched tags. Such tagging may be relatively persistent and/or dynamic based on the metrics, measurements, and specification of matching criteria. Given a resource tagged with a particular tag, other resources may be easily located, Thus inattentive students, machine operators, customers may be identified over long periods of time with persistent tags that may be associated with matching criteria based on long-term metrics such as an average over a period and/or over relative shorter periods based on metrics that may provide changing measurements over time. Similar status and/or time base matching criteria may be specified to tag resources of various types according a rank such as popularity or satisfaction, lab data for human health, presence data such as presence status, and the like. Another example of a type of data that a category of matching criteria may be based on that may be persistent and/or volatile depending on the particular tagging criterion, is matching criteria based on geospatial location. Some resources don't move others move. It should be apparent given the description herein to those skilled in the art of specifying matching criteria that matching and, thus, a tagging criterion may be based on metrics and/.or measures for one or more of attention of a user, interaction of a user, rank, biological attributes, physical attributes, demographic attributes, time, a location, network traffic, network congestion, network performance, and of power,

A tagging criterion may be based on a communication that identifies at least one of the first resource, the tag, and metadata for the first resource, an initiator of the communication, and an acceptor of the communication. For example, attachments exchanged in emails, multimedia messaging service (MMS), and/or other user communications technologies and systems may be identified and tagged according to the teaching herein.

Performing the method illustrated in FIG. 2A-B and/or any of its extension and/or in any of its aspects may include one or more of calling a function or method of an object, sending a message via a network; sending a message via an inter-process communication mechanism such as a pipe, a semaphore, a shared data area, and/or a queue; and/or receiving a request such as poll and responding to invoke, and sending an asynchronous message.

Output devices suitable for presenting a representation of a resource and/or a tag include a visual output device, an audio output device, and a tactile output device. One output device may present a resource and another output device may present a tag with which the resource is tagged.

As described the method may be performed by a non-networked device, a networked device, and/or may be performed may more than one device, and/or by more than one executable environment. As such, one or more of determining criterion information, determining that tagging criterion is met, tagging, and sending presentation information may include sending and/or receiving a message via a network. Further, a message, included in performing any of the subject matter described herein and/or any of its extensions in any of its aspects, may an asynchronous message without a corresponding request.

Exemplary resources that may be tagged include documents and other text data, image data including pictures and video, audio data, form data, streaming data, user accounts, representations of user groups, legal entities, executable entities, hardware components, a network and/or Web based services, and a computer resources such as disks, threads, memory, and the like.

A determination that tagging criterion is met for a resource may be performed in response to an access to the resource by a hardware and optionally by a software component. An access to a resource may be in response to an user input detected via an input device. The access may be detected by detecting the user input. The user input may target and/or otherwise correspond to a UI element presented for accessing and/or for presenting a representation of a resource that may be tagged with a tag for which the tagging criterion is determined.

Determining that a tagging criterion is met may include performing a search operation by a match set component and receiving a result identifying a set of matching resources. The search may be based on a tagging criterion. A criterion match component may operate with a match set component to perform a search operation, provide for performing a search operation, and/or receive results of a search operative via interaction, direct and/or indirect, with a search engine. Alternatively, a separate determination may be made for each resource identified in the result to identify any resources for which the tagging criterion is met.

In an aspect, a resource and/or an attribute of the resource may change. The change may be detected. Determining whether the tagging criterion is met for the resource may be performed in response to detecting the change. Thus determining one or more resources for which a tagging criterion is met may be performed at a given time for resources that may be tagged with the tag. Alternatively or additionally, such a determination may be made when an access to a resource is detected. Alternatively or additionally, such a determination may be made when change to a resource and/or an attribute associated with the resource is detected. Still further, such a determination may be made when a resource is created and/or otherwise initially identified. In yet another aspect, such a determination may be made in response to a user input indicating that the determination is to be performed.

A resource for which a tagging criterion, identified by a matched tag, is met, may be tagged by creating a tagged association that identifies tag and the resource. A tagged association may be stored in a storage location, wherein the storage location may be included in at least one of a volatile data storage medium and a non-volatile data storage medium.

A resource may be tagged with a tag identified by a matched tag automatically in response to the determining that the tagging criterion, identified by the matched tag, is met for the resource. Tagging a resource may be performed automatically in response to creating a matched tag.

A resource may be tagged automatically in response to detecting and/or otherwise identifying the resource. A resource may be detected directly and/or indirectly. In one aspect, a resource is detected indirectly in response to receiving and/or determining an identifier for the resource. Alternatively or additionally, a resource may be detected by detecting, directly and/or indirectly, an access to the resource. The resource may be accessed by a hardware component for processing based on an instruction executed by a processor. A resource may be detected by detecting an access for presenting a representation of the resource to a user via an output device. Detecting the access may include detecting an input corresponding to a UI element that includes a representation of at least one of the tag and the resource. A resource may be detected in a search result set. A search operation that produces a result set may be based on a tag in a matched tag and/or may be based on a tagging criterion in the matched tag.

A resource may be tagged with a tag by creating a tagged association that identifies the tag and the resource. The tag may be identified by identifying a matched tag that identifies the tag. A tagged association may identify a tag by including and/or otherwise identifying tagging information. A tagged association may identify a tagging criterion by including and/or otherwise identifying criterion information. A tagged association may be stored in a memory location which may be contiguous or not with respect to a physical storage medium and/or with respect to a virtual memory or logical storage system, such as file system or database. A memory location including a tagging association may be volatile, persistent, may be split between volatile and persistent memory, and/or may be replicated in one or more volatile and/or persistent memory locations.

To the accomplishment of the foregoing and related ends, the descriptions and annexed drawings set forth certain illustrative aspects and implementations of the disclosure. These are indicative of but a few of the various ways in which one or more aspects of the disclosure may be employed. The other aspects, advantages, and novel features of the disclosure will become apparent from the detailed description included herein when considered in conjunction with the annexed drawings.

It should be understood that the various components illustrated in the various block diagrams represent logical components that are configured to perform the functionality described herein and may be implemented in software, hardware, or a combination of the two. Moreover, some or all of these logical components may be combined, some may be omitted altogether, and additional components may be added while still achieving the functionality described herein. Thus, the subject matter described herein may be embodied in many different variations, and all such variations are contemplated to be within the scope of what is claimed.

To facilitate an understanding of the subject matter described above, many aspects are described in terms of sequences of actions that may be performed by elements of a computer system. For example, it will be recognized that the various actions may be performed by specialized circuits or circuitry (e.g., discrete logic gates interconnected to perform a specialized function), by program instructions being executed by one or more processors, or by a combination of both. The description herein of any sequence of actions is not intended to imply that the specific order described for performing that sequence must be followed.

Moreover, the methods described herein may be embodied in executable instructions stored in a non-transitory computer readable storage medium for use by or in connection with an instruction execution machine, system, apparatus, or device, such as a computer-based or processor-containing machine, system, apparatus, or device. As used here, a “non-transitory computer readable storage medium” may include one or more of any suitable media for storing the executable instructions of a computer program in one or more forms including an electronic, magnetic, optical, and electromagnetic form, such that the instruction execution machine, system, apparatus, or device may read (or fetch) the instructions from the non-transitory computer readable storage medium and execute the instructions for carrying out the described methods. A non-transitory computer readable storage medium is non-transitory. A non-exhaustive list of conventional exemplary non-transitory computer readable storage media includes a portable computer diskette; a random access memory (RAM); a read only memory (ROM); an erasable programmable read only memory (EPROM or Flash memory); optical storage devices, including a portable compact disc (CD), a portable digital video disc (DVD), a high definition DVD (HD-DVD™), and a Blu-ray™ disc; and the like.

Thus, the subject matter described herein may be embodied in many different forms, and all such forms are contemplated to be within the scope of what is claimed. It will be understood that various details may be changed without departing from the scope of the claimed subject matter. Furthermore, the foregoing description is for the purpose of illustration only, and not for the purpose of limitation, as the scope of protection sought is defined by the claims as set forth hereinafter together with any equivalents.

All methods described herein may be performed in any order unless otherwise indicated herein explicitly or by context. The use of the terms “a” and “an” and “the” and similar referents in the context of the foregoing description and in the context of the following claims are to be construed to include the singular and the plural, unless otherwise indicated herein explicitly or clearly contradicted by context. The foregoing description is not to be interpreted as indicating that any non-claimed element is essential to the practice of the subject matter as claimed.

1. A method for identifying a matched tag set, the method comprising:
identifying a first tagging of a first resource with a first tag that is associated with a first tagging criterion by a first matched tag and identifying a second tagging of the first resource with the first tag that is associated with a second tagging criterion by a second matched tag;
receiving selection information identifying the first tag;
identifying, based on the first tagging criterion, a first set including at least one resource when the selection information identifies the first matched tag, wherein each resource in the first set is tagged with the first tag; and
identifying, based on the second tagging criterion, a second resource, not included in the first set, tagged with the first tag when the selection information identifies the second matched tag,
wherein performing at least one of the preceding actions comprising the method includes execution of an instruction by a processor.

2. The method of claim 1 wherein identifying the first tagging and identifying the second tagging includes sending first presentation information to present, along with a resource user interface element that represents the first resource, a first tag user interface element that represents the first tag identified by the first matched tag and second presentation information to present a second tag user interface element that represents the first tag identified by the second matched tag, wherein first tag user interface element has a user detectable first attribute, based the first matched tag, and the second tag user interface element has the user detectable second attribute, based on the second matched tag.

3. The method of claim 2 wherein the first tag user interface element and the second tag user interface element are presented with a user detectable difference based on a difference between the first matched tag and the second matched tag.

4. The method of claim 3 wherein the user detectable difference is based on a difference between the first tagging criterion and the second tagging criterion.

5. The method of claim 3 wherein the user detectable difference is based on a difference between the first set and the second set.

6. The method of claim 5 wherein the user detectable difference indicates an intersection of the first set and the second set is the empty set.

7. The method of claim 5 wherein the user detectable difference indicates an intersection of the first set and the second set is not empty.

8. The method of claim 5 wherein the user detectable difference indicates one of the first set and the second set is a subset of the other of the one of the first set and the second set.

9. The method of claim 2 wherein the first tag user interface element and the second tag user interface element are presented with no user detectable difference in the first attribute and the second attribute.

10. The method of claim 9 wherein the first set and the second set are equal and the first tag user interface element and the second tag user interface element are presented with no user detectable difference in the first attribute and the second attribute, based on first set and the second set being equal.

11. The method of claim 9 wherein the no user detectable difference is defined to indicate to the user that the first set and the second set are at least one of equal and empty.

12. The method of claim 1 wherein identifying the first tagging and identifying the second tagging includes:
determining, based on a second attribute associated with the first resource, that the second tagging criterion is not met for the first resource prior to identifying the second tagging;
detecting a change to the second attribute while the resource user interface element and the first tag user interface element are presented;
detecting that the second tagging criterion is met for the first resource in response to detecting the change; and
identifying the second tagging, in response to detecting that the second tagging criterion is met.

13. The method of claim 12 wherein identifying the first tagging and identifying the second tagging includes sending first presentation information to present, along with a resource user interface element that represents the first resource, a first tag user interface element that represents the first tag identified by the first matched tag; and second presentation information to present a second tag user interface element that represents the first tag identified by the second matched tag, in response to detecting the change, wherein the second tag user interface element is presented automatically in response to the change.

14. The method of claim 1 wherein the selection information identifies both the first matched tag and the second matched tag.

15. The method of claim 1 wherein the selection information identifies a most recent tagging between the first tagging and the second tagging.

16. The method of claim 15 wherein the most recent tagging is detected in response to a removing of one of the first tagging and the second tagging.

17. The method of claim 1 wherein the selection information is received in response to a change in an attribute of a resource.

18. The method of claim 17 wherein the resource is the first resource.

19. A system for identifying a matched tag set, the system comprising:
a tagging component for identifying a first tagging of a first resource with a first tag that is associated with a first tagging criterion by a first matched tag and identifying a second tagging of the first resource with the first tag that is associated with a second tagging criterion by a second matched tag;
a tag handler component for receiving selection information identifying the first tag; and
a match set component for identifying, based on the first tagging criterion, a first set including at least one resource when the selection information identifies the first matched tag, wherein each resource in the first set is tagged with the first tag
a match set component for identifying, based on the second tagging criterion, a second resource, not included in the first set, tagged with the first tag when the selection information identifies the second matched tag;
a processor, wherein at least one of the tagging component, the tag handler component, and the match set component includes an instruction that is executed by the processor during operation of the system.

20. A non-transitory computer readable storage medium embodying a computer program, executable by a machine, for identifying a matched tag set, the computer program comprising executable instructions for:
identifying a first tagging of a first resource with a first tag that is associated with a first tagging criterion by a first matched tag and identifying a second tagging of the first resource with the first tag that is associated with a second tagging criterion by a second matched tag;
receiving selection information identifying the first tag;
identifying, based on the first tagging criterion, a first set including at least one resource when the selection information identifies the first matched tag, wherein each resource in the first set is tagged with the first tag; and
identifying, based on the second tagging criterion, a second resource, not included in the first set, tagged with the first tag when the selection information identifies the second matched tag.
